(19) United States
(12) Patent Application Publication
(10) Pub. No.: US 2025/0212291 A1
(43) Pub. Date: Jun. 26, 2025

(54) DISCONTINUOUS NETWORK ACCESS

(71) Applicant: InterDigital Patent Holdings, Inc., Wilmington, DE (US)

(72) Inventors: Faris Alfarhan, Montreal (CA); Erdem Bala, East Meadow, NY (US); Ananth Kini, Conshohocken, PA (US); Paul Marinier, Brossard (CA); Moon IL Lee, Melville, NY (US); Oumer Teyeb, Montreal (CA)

(73) Assignee: InterDigital Patent Holdings, Inc., Wilmington, DE (US)

(21) Appl. No.: 18/850,696

(22) PCT Filed: Apr. 3, 2023
(86) PCT No.: PCT/US2023/017267

§ 371 Date: Sep. 25, 2024

Related U.S. Application Data
(60) Provisional application No. 63/327,557, filed on Apr. 5, 2022.
(60) Provisional application No. 63/391,357, filed on Jul. 22, 2022.

(51) Int. Cl. H04W 76/28; H04B 7/06; H04L 1/00; H04W 72/231

(52) U.S. Cl. CPC H04W 76/28; H04B 7/0632; H04L 1/0061; H04W 72/231

(57) ABSTRACT

This disclosure pertains to devices, methods, and systems implemented for discontinuous network access. The implementation includes monitoring for a presence indication signal in a second cell. The implementation includes determining to transmit a wake-up signal for the first cell based on detecting the presence indication signal in the second cell and based on a measurement performed on a synchronization signal block (SSB) of the second cell being less than a threshold. The implementation includes transmitting the wake-up signal. The implementation includes monitoring for transmission of an SSB of the first cell after transmitting the wake-up signal. The implementation includes receiving information indicating that the first cell has transitioned to an active state after transmitting the wake-up signal. The implementation also includes transmitting data via the first cell after receiving the information indicating that the first cell has transitioned to the active state.

### CROSS-REFERENCE TO RELATED APPLICATIONS

This application claims priority to U.S. Provisional Application No. 63/327,557, filed on Apr. 5, 2022, and U.S. Provisional Application No. 63/391,357, filed on Jul. 22, 2022, the entirety of which are incorporated herein by reference.

### BACKGROUND

Network energy consumption can be quite significant, or unnecessary at lower cell loads. As such, the network may turn off frequent periodic transmissions on some cells or carriers (e.g., Synchronization Signal Block or System Information transmissions), to enable network (NW) sleep periods. However, the network may not be aware of a sudden increase in wireless transmit/receive unit (WTRU) demand for network access, if the number of active WTRUs change, or the concentration of WTRU increase.

### SUMMARY

This disclosure pertains to devices, methods, and systems for discontinuous network access. In one or more implementations, the WTRU monitors for a discovery signal and presence information in an anchor cell to access a non-anchor cell when the non-anchor cell is in Network Energy Savings (NES) state. The WTRU transmits a wake-up request to access a non-anchor cell, for example, based on receiving the presence information. The WTRU monitors for transmissions from a non-anchor cell, for example, after transmission of the wake-up request. The WTRU changes availability state of a non-anchor cell upon reception of a response from the non-anchor cell. In one or more implementations, the WTRU determines the active availability state associated with a given cell upon reception of, for example, a WTRU-specific or group common Downlink Control Information (DCI), Medium Access Control (MAC) control element (MAC CE), or paging. In one or more implementations, the WTRU adapts Beam Failure Detection (BFD), Radio Link Monitoring (RLM), Reference Signaling/Synchronization Signal Block (RS/SSB) monitoring, Channel State Information (CSI) measurements on a cell as a function of active availability state of the cell. In one or more implementations, the WTRU switches active Bandwidth Part (BWP) to group-common BWP configured for NES upon reception of group common indication. In one or more implementations, the WTRU includes one or more of the following NES WTRU assistance information: a cell index for which change in state is requested, a desired availability state, and a request for on-demand SSB.

In one or more implementations, a WTRU may access resources in a cell, gNB, or Transmission/Reception Point (TRP) with presence indication. In one or more implementations, the WTRU may monitor for a presence indication associated with a sleeping/off gNB. In one or more implementations, the WTRU may receive the presence indication. In one or more cases, the WTRU may assume an availability state associated with the cell (e.g., “Off” or “Deep sleep”). In one or more cases, the WTRU may transmit a switch-on request, WTRU assistance information, or Random Access (RA) after a successful detection of a presence signal. In one or more implementations, the WTRU may monitor additional Synchronization signal blocks (SSBs) and/or CSI-RS resources after the transmission switch-on request or reception of a response to the switch-on request. In one or more implementations, the WTRU may change the cell's availability state after successfully receiving a response from the requested cell to the transmitted or switch-on request.

Devices, methods, and systems for discontinuous network access may include SSB and CSI-RS adaptation. In one or more implementations, devices, methods, and systems are provided for determining a cell's NES state. In one or more cases, the devices, methods, and systems discussed herein may provide an impact on synchronization, an initial access procedure, a BFD, and a Random Access Channel (RACH) based on a discontinuous network transmission of common signals. In one or more cases, the devices, methods, and systems discussed herein may be used such that the WTRU knows whether to measure an MO or not. In one or more cases, the devices, methods, and systems discussed herein may be used such that the WTRU knows whether common cell signals (e.g., synchronization or reference signals) are transmitted as usual, as opposed to not receiving the common cell signals based on bad channel conditions. In one or more cases, the devices, methods, and systems discussed herein may be used to determined measurements associated with a cell in an NES state, including RLM and BFD. In one or more cases, the devices, methods, and systems discussed herein may be used such that the WTRU determines which resources are applicable for data, control, or measurements per availability state. In one or more cases, the devices, methods, and systems discussed herein may be used to determine initial access on alternate cells.

A method for discontinuous network access is provided herein. In one or more implementations, the method includes monitoring for a presence indication signal in a second cell. In an example, the presence indication signal indicates that a first cell is in a low availability state. In one or more implementations, the method includes determining to transmit a wake-up signal for the first cell based on detecting the presence indication signal in the second cell and based on a measurement performed on a synchronization signal block (SSB) of the second cell being less than a threshold. In an example, the wake-up signal is transmitted prior to an expiration of a predetermined time period after reception of the presence indication signal via the second cell. In one or more implementations, the method includes transmitting the wake-up signal. In one or more implementations, the method includes monitoring for transmission of an SSB of the first cell after transmitting the wake-up signal. In one or more implementations, the method includes receiving information indicating that the first cell has transitioned to an active state after transmitting the wake-up signal. In one or more implementations, the method includes transmitting data via the first cell after receiving the information indicating that the first cell has transitioned to the active state.

A wireless transmit/receive unit (WTRU) for discontinuous network access is provided herein. In one or more implementations, the WTRU includes a processor. In one or more implementations, the processor is configured to monitor for a presence indication signal in a second cell. In an example, the presence indication signal indicates that a first cell is in a low availability state. In one or more implementations, the processor is configured to determine to transmit a wake-up signal for the first cell based on detecting the presence indication signal in the second cell and based on a measurement performed on a synchronization signal block (SSB) of the second cell being less than a threshold. In an example, the wake-up signal is transmitted prior to an expiration of a predetermined time period after reception of the presence indication signal via the second cell. In one or more implementations, the processor is configured to transmit the wake-up signal. In one or more implementations, the processor is configured to monitor for transmission of an SSB of the first cell after transmitting the wake-up signal. In one or more implementations, the processor is configured to receive information indicating that the first cell has transitioned to an active state after transmitting the wake-up signal. In one or more implementations, the processor is configured to transmit data via the first cell after receiving the information indicating that the first cell has transitioned to the active state.

### BRIEF DESCRIPTION OF THE DRAWINGS

A more detailed understanding may be had from the following description, given by way of example in conjunction with the accompanying drawings, in which like reference numerals in the figures indicate like elements.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A.

FIG. 1C is a system diagram illustrating an example radio access network (RAN) and an example core network (CN) that may be used within the communications system illustrated in FIG. 1A.

FIG. 1D is a system diagram illustrating a further example RAN and a further example CN that may be used within the communications system illustrated in FIG. 1A.

FIG. 2 is an example time frequency structure of synchronization signal blocks (SSBs).

FIG. 3 is an illustration of example beam sweeping.

FIG. 4A is a diagram illustrating an example configuration of SSB transmission for an anchor cell and a non-anchor cell.

FIG. 4B is a graph illustrating example aspects of the disclosure which may be implemented.

### DETAILED DESCRIPTION

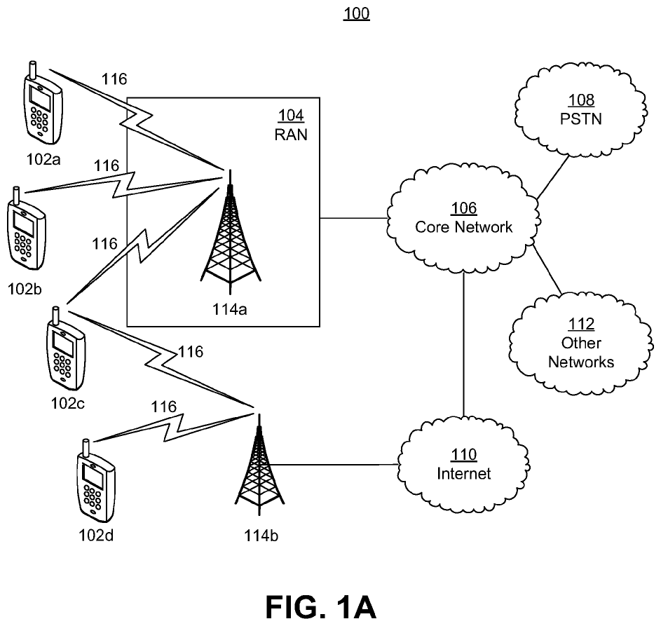

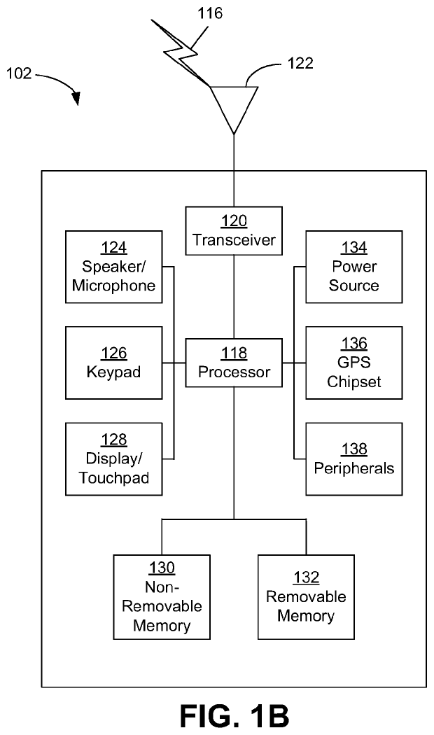

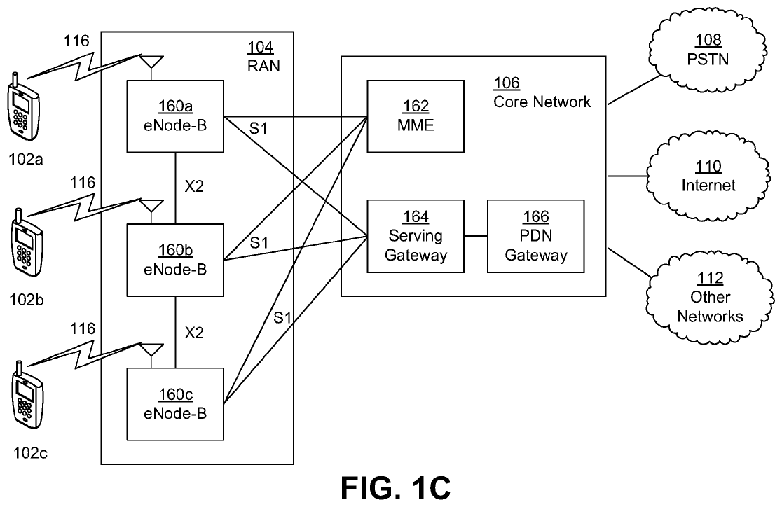

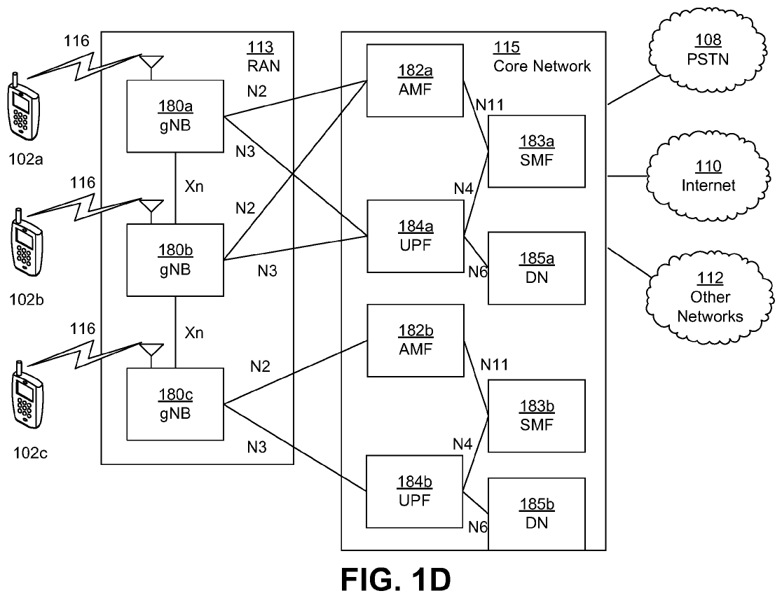

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may Ide one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms, among others, are used herein: Acknowledgement (ACK); Block Error Rate (BLER); Bandwidth Part (BWP); Channel Access Priority (CAP); Channel access priority class (CAPC); Clear Channel Assessment (CCA); Control Channel Element (CCE); Control Element (CE); Configured grant or cell group (CG); Cyclic Prefix (CP); Conventional OFDM (relying on cyclic prefix) (CP-OFDM); Channel Quality Indicator (CQI); Cyclic Redundancy Check (CRC); Channel State Information (CSI); Contention Window (CW); Contention Window Size (CWS); Channel Occupancy (CO); Downlink Assignment Index (DAI); Downlink Control Information (DCI); Downlink feedback information (DFI): Dynamic grant (DG); Downlink (DL); Demodulation Reference Signal (DM-RS); Data Radio Bearer (DRB); enhanced Licensed Assisted Access (eLAA); Further enhanced Licensed Assisted Access (FeLAA); Hybrid Automatic Repeat Request (HARQ); License Assisted Access (LAA); Listen-Before-Talk (LBT); Long Term Evolution (LTE) e.g., from 3GPP LTE R8 and up; Negative ACK (NACK); Network Energy Savings (NES); Modulation and Coding Scheme (MCS); Master Information Block (MIB); Multiple Input Multiple Output (MIMO); New Radio (NR); Orthogonal Frequency-Division Multiplexing (OFDM); Physical Layer (PHY); Process ID (PID); Paging Occasion (PO); Physical Random Access Channel (PRACH); Primary Synchronization Signal (PSS); Random Access (or procedure) (RA); Random Access Channel (RACH); Random Access Response (RAR); Radio access network Central Unit (RCU); Radio Front end (RF); Radio Link Failure (RLF); Radio Link Monitoring (RLM); Remaining System Information (RMSI); Radio Network Identifier (RNTI); RACH occasion (RO); Radio Resource Control (RRC); Radio Resource Management (RRM); Reference Signal (RS); Reference Signal Received Power (RSRP); Received Signal Strength Indicator (RSSI); Service Data Unit (SDU); System Information (SI); System Information Block (SIB); Sounding Reference Signal (SRS); Synchronization Signal (SS); Synchronization signal block (SSB); Secondary Synchronization Signal (SSS); Switching Gap (in a self-contained subframe) (SWG); Semi-persistent scheduling (SPS); Supplemental Uplink (SUL); Secondary node (SN); Transport Block (TB); Transport Block Size (TBS); Transmission/Reception Point (TRP); Time-sensitive communications (TSC); Time-sensitive networking (TSN); Uplink (UL); Ultra-Reliable and Low Latency Communications (URLLC); Wide Bandwidth Part (WBWP); and Wireless Local Area Networks and related technologies (IEEE 802.xx domain) (WLAN).

Network energy savings are being studied in Rel-18 in order to enable a network to attempt to minimize power consumption for device transmission and/or reception. Such minimization is beneficial for reducing operational costs and environmental sustainability. Compared to conventional systems, the design of NR of Rel-15 more efficiently minimizes transmissions from the network when there is no data. For example, always-on cell-specific reference signals (CRSs) are not used in NR. However, there is still potential for energy consumption reduction. For example, the network may consume energy when the network does not transmit during other activities, such as baseband (i.e., digital) processing for reception or beamforming. Moreover, such “idle” power consumption may not be negligible in dense networks even when the network does not serve a WTRU during a given period. Energy consumption may be reduced if the network could turn off these activities when the network is not transmitting to a WTRU. Additionally, NR may support beamforming with many ports (e.g., up to 64 transmit and receive ports), in which energy consumption increases as the number of ports being utilized increases. However, it may not be necessary for the network to utilize the maximum number of ports for all WTRUs. In one or more cases, energy consumption may be reduced if the network could adapt the number of ports to a required or minimum number of ports.

In one or more cases, CSI may include one or more of the following: a channel quality index (CQI), a rank indicator (RI), a precoding matrix index (PMI), a L1 channel measurement (e.g., RSRP such as L1-RSRP, or SINR), a CSI-RS resource indicator (CRI), a SS/PBCH block resource indicator (SSBRI), a layer indicator (LI), and/or any other measurement quantity measured by the WTRU from the configured CSI-RS or SS/PBCH block. In one or more cases, UCI may include CSI, HARQ feedback for one or more HARQ processes, a scheduling request (SR), a link recovery request (LRR), CG-UCI, and/or other control information bits that may be transmitted on the PUCCH or PUSCH. In one or more cases, any channel conditions relating to the state of a state of the radio/channel may be determined by the WTRU based on one or more of a WTRU measurement, L3/mobility-based measurements, an RLM state, and/or channel availability in an unlicensed spectrum. For example, the WTRU may determine channel conditions based on a WTRU measurement, such as, but not limited to, L1/SINR/RSRP, CQI/MCS, channel occupancy, RSSI, power headroom, exposure headroom, and the like. In another example, the WTRU determines channel conditions based on one or more L3/mobility-based measurements, such as but not limited to, RSRP, RSRQ, and the like. In yet another example, the WTRU determines channel conditions based on channel availability in an unlicensed spectrum. For instance, the WTRU may determine whether the channel is occupied based on a determination of an LBT procedure. In another instance, the WTRU may determine whether the channel has experienced a consistent LBT failure. In one or more cases, a PRACH resource may be provided, for example, but not limited to, in frequency. In one or more cases, a PRACH occasion (RO) may be provided, for example, but not limited to, in a measurement of time. In one or more cases, a preamble format may be provided, for example, but not limited to, in terms of total preamble duration, sequence length, guard time duration, and/or in terms of length of a cyclic prefix. In one or more cases, a certain preamble sequence may be used for the transmission of a preamble in a random access procedure. In one or more cases, the PRACH resource may be characterized based on one or more of a frequency resource, a time resource, a preamble format, and the like. A frequency resource may include, for example, but not limited to, a subcarrier, RB, and the like. A time resource may include, for example, but not limited to, a PRACH occasion, symbol, subframe, and the like. A preamble format may include, for example, but not limited to, one or more of a total preamble duration, a sequence length, a guard time duration, and in terms of length of a cyclic prefix.

In one or more cases, a property of scheduling information (e.g., an uplink grant or a downlink assignment) may include one or more of the following: a frequency allocation; an aspect of time allocation, such as a duration; a priority; a modulation and coding scheme; a transport block size; a number of spatial layers; a number of transport blocks to be carried; a TCI state or SRI; a number of repetitions; and a determination of whether the grant is a configured grant type 1, type 2, or a dynamic grant. In one or more cases, an indication by DCI may include one or more of the following: an explicit indication by a DCI field or by RNTI used to mask CRC of the PDCCH; and an implicit indication by a property, such as, but not limited to, a DCI format, DCI size, CORESET or search space, an aggregation level, an identity of a first control channel resource (e.g., an index of a first CCE) for a DCI. In one or more cases, the mapping between the property and the value may be signaled by the RRC or MAC. For example, the WTRU may signal the mapping between the property and the value via the RRC or MAC.

In one or more cases, NR System Information (SI) may include a MIB (master Information block) and a number of SIBs (System Information Blocks). In one or more cases, the SIBs may be divided into Minimum SI and Other SI. In one or more cases, minimum SI may carry information required for initial access and for acquiring any other SI. In one or more cases, minimum SI may include MIB and SIB1. For a WTRU to be allowed to camp on a cell, the WTRU may acquire the contents of the minimum SI of that cell. In one or more cases, other SI may include all SIBs not broadcasted in the Minimum SI. In one or more cases, the WTRU may not receive these SIBs before accessing the cell. In one or more cases, other SI may also be known as On-Demand SI because the gNB may transmit/broadcast these SIBs when explicitly requested by WTRU(s). The gNB may transmit/broadcast these SIBs when explicitly requested by WTRU(s) for network energy saving purposes.

In one or more cases, MIB may include cell barred status information and essential physical layer information of the cell required to receive further system information, e.g., a CORESET #0 configuration. In one or more cases, MIB may be periodically broadcast on BCH. For example, the MIB may be periodically broadcast on BCH with a periodicity of 80 ms, and within the 80 ms, a repetitive transmission may occur. In one or more cases, SIB1 may define the scheduling of other system information blocks. Further, the SIB1 may include information required for initial access. In one or more cases, SIB1 may also be referred to as the Remaining Minimum SI (RMSI). In one or more cases, SIB1 may be periodically broadcast on DL-SCH or sent in a dedicated manner on DL-SCH to UEs in RRC_CONNECTED.

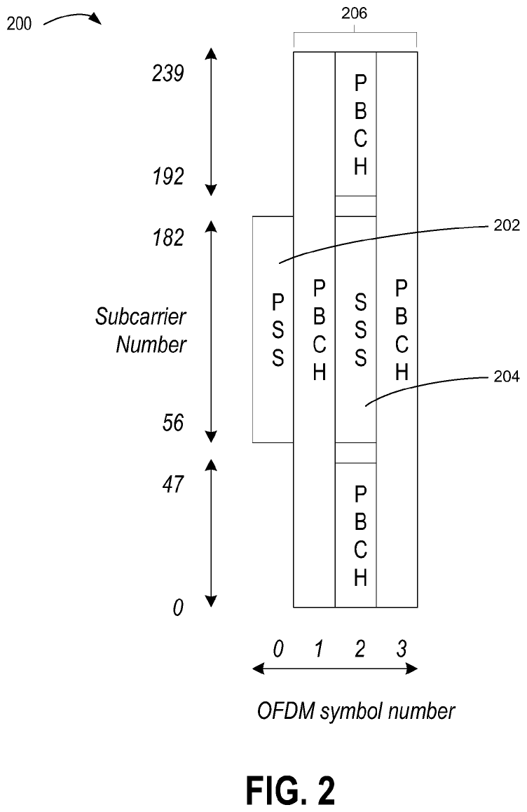

FIG. 2 illustrates an example time frequency structure of a transmission 200 that includes synchronization signal blocks (SSBs). In one or more cases, the Synchronization Signal and PBCH block (SSB) may include primary and secondary synchronization signals (PSS, SSS respectively) 202, 204. Each of PSS 202 and SSS 204 occupy 1 symbol and 127 subcarriers. The SSB may include PBCH 206 spanning across 3 OFDM symbols and 240 subcarriers, but on one symbol leaving an unused part in the middle for SSS 204 as show in FIG. 2. In one or more cases, the possible time locations of SSBs within a half-frame may be determined by sub-carrier spacing and the periodicity of the half-frames in which SSBs are transmitted as configured by the network. Different SSBs may be transmitted, for example, by an eNB, in different spatial directions. For example, different SSBs may be transmitted in different spatial directions during a half-frame. The different SSBs may be transmitted in different spatial directions using, for example, different beams, and/or spanning the coverage area of a cell.

Within the frequency span of a carrier, multiple SSBs may be transmitted. In some cases, the PCIs of SSBs transmitted in different frequency locations may not be unique. For instance, different SSBs in the frequency domain may have different PCIs. In one or more cases, when an SSB is associated with an RMSI, the SSB may be referred to as a Cell-Defining SSB (CD-SSB). In one or more cases, a PCell may be associated with a CD-SSB located on the synchronization raster. In one or more other cases, a PCell may always be associated with a CD-SSB located on the synchronization raster.

In one or more cases, the WTRU may assume a band-specific sub-carrier spacing for the SSB. In one or more other cases, the WTRU may assume a band-specific sub-carrier spacing for the SSB unless a network has configured the WTRU to assume a different sub-carrier spacing.

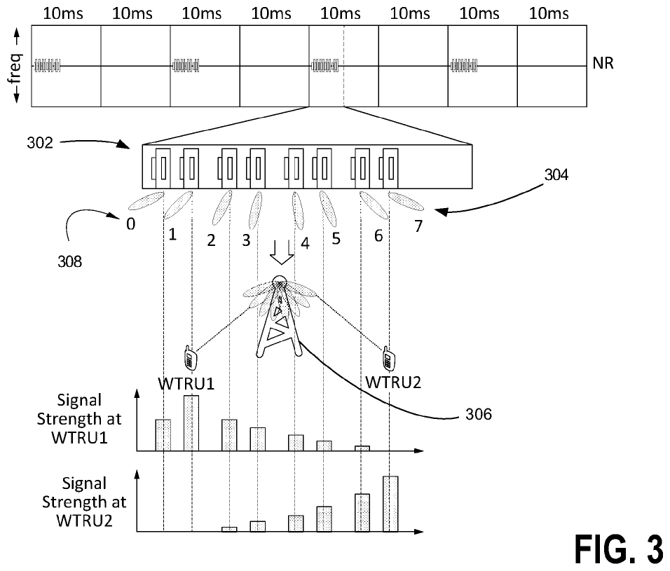

In one or more cases, several beams may be associated with a given cell. In one or more cases, multiple SSBs may be transmitted within a given cell on different beams (i.e., for cases of beam sweeping). FIG. 3 illustrates an example of a beam sweeping performed between a gNB 306 and a plurality of WTRUs (e.g., a first WTRU1 and a second WTRU2). As shown in FIG. 3, multiple SSBs 302 may be transmitted with a certain interval. Further, each SSB may be identified by a unique number 308, for example, an SSB index. The SSB Index 308 may be mapped to each beam. Each SSB may be transmitted via a specific beam radiated in a certain direction. Multiple WTRUs, such as the first WTRU1 and the second WTRU2, may be located at various places around the gNB 306. As illustrated in FIG. 3, a WTRU may measure a signal strength of each SSB that the WTRU detected for a certain period (e.g., a period of one SSB Set). Further, based on the measurement result, the WTRU may identify the SSB index with the strongest signal strength. For example, as shown in FIG. 3, Beam #1 is the best beam (i.e., the selected beam) for the first WTRU1. That is, Beam #1 provides the strongest signal strength for the first WTRU1. In another example, as shown in FIG. 3, Beam #7 is the best beam for the second WTRU2. That is, Beam #2 provides the strongest signal strength for the second WTRU2.

In one or more cases, the number of different beams being transmitted may be determined based on the number of SSBs being transmitted within a SSB Burst Set. The SSB Burst Set may be, for example, but not limited to, a set of SSBs transmitted in 5 ms window of a SSB transmission. For example, in FR1, the maximum number of SSBs within an SSB set may be 4 or 8, while for FR2, a maximum number of SSBs within an SSB set may be 64.

In one or more cases, the WTRU may determine whether the WTRU may transmit or receive on certain resources. For example, the WTRU may determine whether the WTRU may transmit or receive on certain resources based on a network availability state. The network availability state may include information that implies and/or indicates the gNB's power savings status. In one or more cases, the availability state may correspond to a network energy savings state or a gNB activity level. In one or more cases, the availability state may be uplink specific (e.g., DRX) or downlink specific (e.g., DTX). Additionally or alternatively, the availability state may change from symbol to symbol, slot to slot, frame to frame, or on a longer duration of granularity. In one or more cases, the WTRU may determine the availability state. In one or more other cases, the network may indicate the availability state. An availability state may be, for example, but not limited to, “on”, “off”, “dormant”, “micro sleep”, “deep sleep”, or other like states. Such states may be abstracted by network (NW) configuration parameters and/or values. The “off” availability state may indicate that the gNB's baseband hardware is turned off. For example, the “off” availability state may indicate that the gNB's baseband hardware is completely turned off. The “sleep” availability state may indicate that the gNB wakes up periodically to transmit certain signals (e.g., but not limited to a presence signals, synchronization, reference signals, and the like) or to receive certain UL signals. An availability state may be, for example, configured with a periodic availability period and a non-availability period. In some availability states, one or more DL or UL resources may not be available during certain periods of time (e.g. during a non-availability period). As such, the network may turn off baseband processing and other activities. In one or more cases, some measurement resources (e.g., SSBs or CSI-RS) may be available in certain availability states.

In one or more cases, the WTRU may transmit a request to the network to modify the availability state. For example, the WTRU transmits a wake-up request to the network to request that the network modify the availability state to include available resources that would satisfy WTRU requirements. The wake-up request may include a transmission that a low-complexity receiver may decode at the gNB. In some cases, the wake-up request transmission may require minimal energy consumption requirement to be decoded. It is noted that a wake up request, turn on request, or switch on WTRU assistance information may be use interchangeably as discussed herein. In one or more availability states (e.g., “micro sleep” or “deep sleep”), the WTRU may exclusively use a wake up request. Further, the wake up request may refer to a physical uplink signal transmitted by the WTRU to request a change of availability state. The physical layer design of a wake-up request signal is further detailed in U.S. Application No. 63/275,207, which is incorporated herein by reference in its entirety. In one or more other cases, a switch on request may be a physical layer or an L2 indication from the WTRU to the network. The WTRU may deliver the L2 indication as, for example, but not limited to, one or more of a MAC CE, UCI, RRC signalling, PUCCH, RACH indication, or the like. Additionally or alternatively to the aforementioned, the WTRU may include switch on WTRU assistance information and/or a positioning report.

In one or more cases, the WTRU determines an availability state from reception of availability state indication from, for example, L1/L2 signalling (e.g., a group common DCI or an indication). In one or more other cases, the WTRU implicitly determines an availability state from receiving periodic DL signalling or not receiving periodic DL signalling. In one or more cases, the WTRU determines if a resource is available for transmission/reception and/or measurements for the determined network availability state if the WTRU determines that the resource is applicable in the active availability state. An availability state may be applicable to at least one transmission, reception, or measurement resource. An availability state may be applicable to at least one time period, such as a time slot or time symbol. An availability state may be applicable to, for example, but not limited to, one or more of a serving cell, a cell group, a frequency band, a bandwidth part, a TRP, a set of spatial elements, and a range of frequencies within a bandwidth part, and the like.

In one or more cases, network energy consumption may be quite significant, and in many cases, unnecessary, for example, during quiet hours. In some cases, to reduce energy consumption, the network may turn off small cells or FR2 power hungry cells and rely on macro-cells for coverage during quiet hours. In one or more cases, gNBs may combine information including, but not limited to WTRU measurements, WTRU assistance information, interference status, load information, proprietary information to determine which cells to turn off and which cells to rely on. In one or more cases, turning off gNB informs neighboring cells if the neighboring cells should be turned on/off. However, in some cases, the network may not be aware of a sudden increase in demand for network access, for instance, if the number of active WTRUs change, or if the concentration of WTRUs increases. Further, some WTRUs may experience a coverage loss when capacity boosting cells are turned off. In some cases, the WTRUs may want to inform the network about the coverage loss. Additionally, in busy hours, network power consumption may be quite significant, especially if all or a large number of bands, carriers, antenna chains, beamforming antennas are used. As such, network access capabilities may be adapted in busy hours to reduce energy consumption. In one or more cases, power consumed that is related to MIMO may be proportional to one or more of the number of active chains, number of active TRPs, number of SSBs, number of spatial multiplexing streams and MU-MIMO schemes being used, and whether narrow beams are used. Accordingly, the disclosure provided herein provides solutions that enables the network to know when the network can turn off transmission and reception or use a reduced number of antenna ports for such resources without compromising quality of service of the served WTRUs.

In one or more cases, a WTRU may be configured to receive a dormant cell presence indication. In some cases, the WTRU monitors for a presence indication associated with a sleeping/off gNB. Additionally or alternatively, the WTRU may monitor for a presence indication associated with a sleeping/off gNB after satisfying conditions for transmitting switch-on request/assistance information. In one or more cases, the WTRU may monitor for reception of a presence indication or a signal associated with a gNB configured with one or more availability states. An availability state may be for example on, off, dormant, or deep sleep. The presence indication may be a physical downlink signal transmitted by the associated cell or gNB that is sleeping. For example, the gNB may be sleeping in certain availability states (e.g., deep sleep, micro sleep, dormant, or off). Alternatively, the presence indication may be downlink information bits that are delivered to the WTRU. For example, the downlink information bits may be delivered to the WTRU via broadcast signalling (e.g., SIB). In another example, the downlink information bits may be delivered to the WTRU via dedicated signalling (e.g., RRC signalling or MAC CE). The WTRU may conditionally monitor presence indication occasions if any of the triggers/conditions for transmitting wake-up WTRU assistance information or a switch-on request are met.

In one or more cases, the WTRU may receive the presence indication via a different serving cell and/or a different TRP in the cell. In some cases, a different serving gNB may monitor or deliver the presence indication if the associated gNB is configured in a certain availability state (e.g., Off or dormant). In some cases, the WTRU may monitor a presence indication per TRP. In such cases, the presence indication may be associated with a specific TRP. In some cases, a different TRP may transmit the presence indication that is associated with a certain TRP.

In one or more cases, the WTRU may determine a cell's availability state from at least one property of the availability state indication of the received presence indication that is associated with the cell. The presence indication may indicate an availability state associated with the cell pertaining to the presence indication occasion. In some cases, the determined or indicated availability state may be applicable until the next presence indication occasion.

In one or more cases, the WTRU is configured with monitoring occasions. The WTRU may be configured with monitoring occasions to detect a presence indication associated with a cell, TRP, or carrier. In some cases, the carrier may be located on a different cell. In some case, the WTRU may be configured with presence indication occasions to monitor DL signals and/or indications associated with the presence indication. The WTRU may be configured with a periodicity associated with a presence indication per cell. The WTRU may, in addition or in the alternative to the periodicity association, be configured to monitor occasion patterns to detect the cell's presence indication. In one or more cases, the presence signal may be a DL signal or channel. In some cases, the presence signal is a DL signal or channel that includes a SSB signal, a reference signal, a PDCCH transmission, and/or a PDCSCH transmission. For each cell or carrier, the WTRU may be configured with an association between one or more of SSB(s), RS, or other DL signals and a presence signal for the cell.

In one or more cases, the WTRU transmits one or more of a switch on request, WTRU assistance information, or RA after successfully detecting a presence signal. The WTRU may transmit and/or trigger one or more of a wake-up request, a switch on request, and a transmission of wake-up WTRU assistance information. For instance, the WTRU may transmit and/or trigger one or more of a wake-up request, a switch on request, and a transmission of wake-up WTRU assistance information upon successfully detecting the presence signal. In some cases, the WTRU may initiate a new random-access procedure on the cell. For example, if the WTRU successfully detects a presence indication associated with the cell, the WRTU initiates a new random-access procedure on the cell. In some cases, the WTRU may start a timer upon successful detection of a presence signal, and/or transmit a wake-up request upon the expiration of a timer. In some cases, the WTRU may assume the availability state is applicable with the associated cell while the timer is running. In some cases, the WTRU may fallback to a different or a default availability state after the expiration of the timer.

In one or more cases, the WTRU may determine or change the active availability to a predefined or configured value if the WTRU detects or does not detect the presence signal. In some cases, the WTRU may assume an availability state is not active if the WTRU does not detect a presence signal associated with the state. For example, the WTRU assumes the availability state to be Off, micro-sleep, or deep sleep if the WTRU does not detect or receive a presence signal associate with the availability state “On”.

In some cases, the WTRU determines that a presence indication signal or the gNB's response to the wake-up signal is not detected or not received based on the signal being measured having a channel quality metric (e.g., RSRP or SINR) below a configured threshold. The WTRU may determine that the presence signal is detected based on the WTRU synchronising to PSS/SSS signals transmitted as part of the presence signal. The WTRU may sleep, activate DRX, or change a DRX cycle of the WTRU, until the next presence signal indication. In some cases, the WTRU sleeps, activates DRX, or changes the DRX cycle of the WTRU based on the WTRU not successfully receiving and detecting a presence signal, and/or if the WTRU cannot connect to other serving cells. In some cases, the WTRU may monitor the presence signal of another serving cell if the presence signal was not successfully detected in the serving cell or the last serving cell (e.g., a last serving cell index prior to performing a handover).

In some cases, the WTRU may use a counter or a presence indication detection timer before changing active availability state based on the reception of a presence indication. In some cases, the WTRU may use the counter or the presence indication detection timer before making an availability state determination based on the reception of a presence indication. In some cases, the WTRU changes the availability state if the detection timer expires. In other cases, the WTRU changes the availability state if the WTRU counts a consecutive number of missing samples of the presence indication. For example, the WTRU may be configured with a period for measuring presence indication samples. The WTRU may consider the presence indication is not detected if the WTRU does not measure the presence indication. For instance, the WTRU considers the presence indication is not detected if the WTRU determines that a channel measurement is less than a threshold, before the end of the detection window.

In one or more cases, the WTRU may change the cell's availability state. For example, the WTRU changes the cell's availability state after a successful reception of a response from the requested cell to the transmitted or switch-on request. In some cases, the WTRU may change the availability state associated with detecting a presence signal (e.g., WTRU assumes an “On” state) after the WTRU successfully receives a response from the requested cell to the transmitted WTRU assistance information or switch-on request. In some cases, the received response may be a DL signal or channel or an L2 message. The DL signal or channel may be, for example, but not limited to, SSB(s), CSI-RS, PRS, PDCCH, DCI, PDSCH, HARQ-ACK. The L2 message may be, for example, an RRC message, DL MAC CE, Msg2, MsgB, or Msg4.

In one or more cases, the WTRU may monitor additional SSBs and/or CSI-RS resources. For example, the WTRU may monitor additional SSBs and/or CSI-RS resources after the transmission switch-on request. In another example, the WTRU may monitor additional SSBs and/or CSI-RS resources after reception of a response to the switch-on request. In some cases, the WTRU may start monitoring additional TRPs, SSBs and/or CSI-RS resources after the transmission of the wake-up WTRU assistance information and/or the switch-on request. In some cases, the WTRU may start monitoring additional TRPs, SSBs and/or CSI-RS resources after a successful reception of the response to the switch-on request. The WTRU may change the availability state associated with detecting a presence signal (e.g., On) after the WTRU successfully measures channel conditions (e.g., RSRP, SINR) on measurement resources of the associated cell that measure above a configured threshold.

In some cases, a physical layer structure of a presence indication signal may include one or more structures described herein. For example, the presence indication signal may be a simplified or stripped down SSB signal, such as a PSS/SSS without PBCH multiplexed, a wide beam SSB, or an omni-directional SSB. In some cases, the WTRU may monitor and attempt to synchronize to the simplified or stripped down SSB signal on a different synchronization raster than the one used/configured for legacy WTRUs. In another example, the presence indication signal may be a PRS. In some cases, the WTRU may receive the PRS from a different cell or TRP. In some cases, the WTRU may receive the PRS on a configured subset of PRS resources. In another example, the presence indication signal may be a CSI-RS. In some cases, the WTRU may receive the CSI-RS from a different cell or TRP. In some cases, the WTRU may receive the CSI-RS on a configured subset of CSI-RS resources. In another example, the WTRU may detect the presence indication based on energy sensing the ether. For example, the WTRU may detect a DL signal associated with a wake-up radio. In yet another example, the presence indication signal may be a signal generated from one or more sequences, such as, but not limited to a Zadoff-Chu sequence, an M-sequence, or a Gold sequence. In another example, the presence indication signal may be a PDSCH, or PDCCH received on a different cell or TRP. In some cases, the WTRU may receive the PDSCH or PDCCH on a configured subset of resources, coresets, or search spaces. In another example, the presence indication signal may be one or more SSBs received from a different cell or TRP. In some cases, the WTRU may receive the one or more SSBs on a configured subset of SSB occasions.

In one or more cases, the WTRU may monitor for a synchronization relation between presence indication and SSBs. In one or more cases, the WTRU may monitor for a presence indication during configured or predefined occasions. For example, the predefined occasions may be tied to SSB transmission times or a subset of the SSB transmission times for the serving cell associated with the indication according to a defined timing relationship. The timing of presence indication occasions or their timing relationship with SSB may be indicated by higher layers, such as, but not limited to, system information.

In some cases, the WTRU may perform a time-frequency synchronization procedure prior to attempting to detect a presence indication signal. The WTRU may use the presence indication signal to perform time-frequency synchronization. In some cases, the WTRU may monitor for presence indication on the same cell associated with the presence indication if the presence indication is time-frequency synchronized to that cell. The WTRU may use a new subset of synch raster (or a different base sequence) to monitor and/or detect a presence signal based on SSB transmission.

In one or more cases, upon the WTRU successfully receiving presence indication or the gNB's response to a following wake-up request or a switch-on request, the WTRU assumes a different set of available SSBs in the cell. For example, the WTRU may assume a different set of available SSBs in the cell, such as, but not limited to, the legacy SSBs associated with the “On” availability state. In some cases, the WTRU may perform another synchronization and/or initial access procedure upon the detection of the set of available SSBS. In one or more cases, the WTRU may assume a different SSB pattern and/or periodicity upon detection of a stripped down SSB or enhanced SSB format. In one or more cases, the WTRU may read RMSI for an alternate SSB pattern/configuration upon reception of a stripped down SSB/presence signal.

In one or more cases, the WTRU receives the presence indication having an L2 structure. In some cases, the WTRU receives the presence indication as information. In some cases, the WTRU receives the presence indication from a different cell, carrier, and/or TRP. In some cases, the presence indication may be an RRC message or a DL MAC CE. The presence indication L2 signal/information may include a variety of information. For example, the presence indication L2 signal/information may include associated cell(s) indices, for which the presence indication is applicable. In another example, the presence indication L2 signal/information may include associated TRP(s) indices, for which the presence indication is applicable. In another example, the presence indication L2 signal/information may include associated carriers(s) or frequency bands, for which the presence indication is applicable. In another example, the presence indication L2 signal/information may include an availability state associated with the indicated cell(s), TRP(s), or carrier(s). In another example, the presence indication L2 signal/information may include related synchronization, cell search, or initial access information that may be used on the indicated cells (e.g., PRACH resources). In another example, the presence indication L2 signal/information may include a time duration associated with the availability state. In some cases, the time duration associated with the availability state may be implicitly implied from the reception of the L2 presence indication. In one or more cases, the WTRU may assume that the cell is no longer available (or the indicated/implied availability state is no long applicable) after the expiry of such timer. In some cases, the WTRU may assume that the indicated/implied availability state is no longer applicable. In another example, the presence indication L2 signal/information may include an RRC message or additional configurations. In another example, the presence indication L2 signal/information may include a MAC CE sub-header or identifier.

In one or more cases, the WTRU may be configured with a UL availability window. In some cases, during the UL availability window, the WTRU transmits UL signals after detecting a presence indication, and/or at preconfigured periodic occasions. In some cases, the WTRU may maintain a “gNB activity timer”. In some cases, the activity timer starts after the WTRU receives the response to the WTRU's wakeup request signal, WTRU assistance information, or the switch-on request. In some cases, the WTRU starts the “gNB activity timer” after the WTRU receives the presence indication (e.g., an SSB) or an indication by DCI or MAC CE (e.g. a WTRU-specific scheduling DCI). The WTRU may start the gNB activity timer at predefined periodic occasions. In some cases, the configuration of the predefined periodic occasions may be provided by broadcast or dedicated signaling. In some cases, the periodicity between UL windows may be configured per availability state. In some cases, The WTRU applies the periodicity according to the active availability state. In one or more cases, the WTRU may maintain gNB activity times for the DL and UL directions independently. For example, the WTRU may maintain a DL gNB activity timer and another UL gNB activity timer.

While the gNB activity timer is running or during the gNB active time (e.g., during the availability period of an availability state), the WTRU may transmit UL signals, UCI, or data (e.g., PUSCH, PUCCH, PRACH, SRS, UCI, CQI reports, and/or measurement reports) and/or monitor for DL signals and channels (e.g., PDSCH, PDCCH, CSI-RS, SSBs, PRS, or channel measurement signals). Upon the expiration of the “gNB activity timer”, the WTRU may switch to a different availability state. In some cases, the WTRU extends the gNB activity timer after a UL transmission or a DL reception. Upon expiration of the “gNB activity timer”, the WTRU falls back to a less periodic gNB activity cycle or availability state. In some cases, in the less periodic gNB activity cycle or availability state, a UL availability opportunity window and/or the presence indication may occur at a different configured periodicity.

In one or more cases, the WTRU monitors for a presence indication prior to the UL availability window. In some cases, the WTRU monitors for the presence indication prior to the UL availability window in a subset of gNB activity cycle or availably states. In one or more cases, the WTRU may determine that the UL availability window is applied conditionally on successfully receiving the presence indication or an indication from the network by DCI or MAC CE. In some cases, the WTRU may determine that the UL availability window is applied conditionally on successfully receiving the presence indication based on a subset of gNB activity cycles or availability states. For example, the WTRU starts the UL availability window based on the WTRU receiving a presence indication, and the WTRU is in a “deep-sleep”, “dormant”, or an “Off” availability state. The WTRU assumes the UL availability window started automatically at preconfigured periodic occasions in “On” or “Micro sleep” availability states.

In one or more cases, the WTRU may be configured with switch on request and wake-up WTRU assistance information. In some cases, the WTRU may be configured by broadcast or dedicated signaling with a subset of cells, carriers, or bands as “capacity boosting cells/bands”. In some cases, based on the configuration, the WTRU may send a switch on/wake up request and/or wake-up WTRU assistance information. For a given cell (e.g., PCI), the WTRU may be configured with complementary/associated “capacity boosting cells or carriers”. A capacity boosting cell or carrier may be, for example, a small cell associated with a macro cell. In some cases, the WTRU may consider cells of an SCG/SN as capacity boosting cell(s) associated with one or more cells in the MCG/MN. The WTRU may consider carriers of the same gNB (e.g., SCells) as capacity boosting cells associated with the primary carrier on that same gNB (e.g., the PCell). The WTRU may implicitly determine capacity boosting cells as any cells configured with presence indication, in which the indication is sent from the same cell or a different cell.

For capacity boosting cells associated with another cell, the WTRU may monitor the presence indication on the associated cell and/or transmit the wake-up WTRU assistance information or request using uplink resources of that associated cell. In one or more cases, the WTRU triggers and/or transmits a switch-on request or wake-up WTRU assistance information. For example, the WTRU triggers and/or transmits a switch-on request or wake-up WTRU assistance information to indicate a change of availability state for cells designated as capacity boosting. In some cases, the WTRU triggers and/or transmits a switch-on request or wake-up WTRU assistance information to indicate a change of availability state for cells designated as capacity boosting based on a condition or trigger being met. In one or more cases, a condition or trigger may include detecting a cell presence signal. For example, detecting a cell presence signal may include detecting the cell presence signal in the past period associated with measuring the presence indication. In another example, detecting a cell presence signal may include detecting the cell presence signal after the triggering condition associated with transmitting wake-up assistance information is satisfied. For instance, the triggering condition associated with transmitting wake-up assistance information may be satisfied by detecting that the presence signal associated with the requested cell with channel quality metric is above a threshold. In one or more cases, a condition or trigger may include not detecting a presence signal associated with the cell. For example, not detecting a presence signal associated with the cell may correspond to not detecting the presence signal in the past period associated with measuring the presence indication. In one or more cases, a condition or trigger may be based on channel measurements, in which the condition or trigger is met when the channel measurement measures above or below a configured threshold. In an example, the channel measurement may be a measured RSSI or RS-SINR. In another example, the channel measurement may be a lack of SSB samples to measure on the requested cell or the serving cell. In another example, the channel measurement may include a cell's configured SSB(s) and/or not detecting a CSI-RS or measuring the CSI-RS below a configured threshold. In one or more cases, the WTRU measurement may be a physical layer measurement, or a L3 measurement. A physical layer measurement may be, for example, but not limited to, SINR/RSRP, CQI, channel occupancy, RSSI, power headroom, exposure headroom, and the like. A L3 measurement may be, for example, but not limited to, RSRP, RSRQ, and the like. The WTRU may include such measurements in the WTRU assistance information contents. In one or more cases, a condition or trigger may be based on channel measurements, in which the condition or trigger is met when the WTRU detects a high load or interference, when the WTRU does not detect an SSB, or when the WTRU does not detect a PSS/SSS on the request cell or any cell. In one or more cases, a condition or trigger may be based on channel measurements, in which the condition or trigger is met when the WTRU detects channel availability in an unlicensed spectrum. For example, the WTRU may detect channel availability in an unlicensed spectrum when the channel is occupied based on a determination of an LBT procedure. In another example, the WTRU may detect channel availability in an unlicensed spectrum when the channel is deemed to have experienced a consistent LBT failure. For instance, the WTRU may trigger wake-up WTRU assistance information after the detection of a consistent UL LBT failure.

In one or more cases, a condition or trigger may include an arrival of new data. For example, a WTRU may determine that a condition or trigger is met when data arrived from one or more of a subset of DRBs, SRBs, LCHs, LCGs, and the like. In another example, the WTRU may determine that a condition or trigger is met when the arrived data is associated with a certain priority level or index. The WTRU may reflect such data in the assistance information contents.

In one or more cases, a condition or trigger may include a triggering of an RRC state change or an RRC procedure. The RRC procedure may be, for example, but not limited to, an RRC resume, RRC establishment, RRC re-establishment, and the like. In one or more cases, a condition or trigger may include a triggering reception of an RRC message (e.g., RRC release).

In one or more cases, a condition or trigger may include one or more of performing a positioning procedure, transmitting a positioning report, and determining a location that is within the cell's coverage as the best server. For example, the WTRU triggers wake-up WTRU assistance information if the WTRU determines the WTRU's position is within the best server coverage of the capacity boosting cell. The best server coverage may be, for example, the area in which the WTRU measures the capacity cell as having the best channel conditions compared to other cells in the same frequency. In one or more cases, the WTRU may include the location of the WTRU in the WTRU assistance information. In one or more cases, the WTRU may be allowed, or conditioned, to transmit wake-up WTRU assistance information based on the WTRU's determined location being within a certain area or within a predetermined coverage of the requested cell(s). The certain area may include an area of coverage of another alternative serving cell or a configured area per cell, such as but not limited to, a distance from the known location of the requested gNB(s). In one or more cases, a condition or trigger may include an amount of buffered data being above a threshold. The WTRU may trigger a wake up request based on the amount of buffered data being above a configured or predefined threshold. For example, based on a configured subset of DRBs, LCHs, or LCGs, the WTRU triggers a wake up request if the amount of buffered data is above a configured or predefined threshold. The WTRU may include the data volume in the WTRU assistance information (e.g., a BSR or a modified BSR for a subset of LCHs/RBs/LCGs). The WTRU may be configured with a the list of RBs or priorities that may trigger the inclusion/transmission of WTRU assistance information.

In one or more cases, a condition or trigger may include triggering a BSR and/or SR. For example, the WTRU may trigger a wake-up WTRU assistance information based on a new BSR and/or a new SR being triggered. In some cases, the WTRU may trigger a wake-up WTRU assistance information based on a new BSR and/or a new SR being triggered if the new SR is for a given SR configuration. In an example, the triggering of transmission of wake-up assistance information may trigger a new BSR.

In one or more cases, a condition or trigger may include an availability of UCI or data to transmit (e.g., HARQ ACK, CSI, or PMI), the priority associated with the UCI, or the LCH or DRB associated with the UCI. For example, the WTRU may trigger the transmission of wake-up WTRU assistance information based on the availability of UCI or data to transmit, the priority associated with the UCI, or the LCH or DRB associated with the UCI.

In one or more cases, a condition or trigger may include a detection of a beam failure or an RLM event (e.g., RLF). For example, the WTRU may trigger the transmission of wake-up WTRU assistance information based on the WTRU detecting a beam failure or RLF on a cell associated with a capacity boosting cell and/or current active serving cell of the WTRU.

In one or more cases, a condition or trigger may include triggering a of L3 or mobility event. The WTRU may include such trigger in the WTRU assistance information. For example, the WTRU may include the trigger in the WTRU assistance information as the WTRU mobility status.

In one or more cases, a condition or trigger may include entering a certain DRX state, cycle, or power saving mode, including short or long connected mode DRX. In one or more cases, a condition or trigger may include deactivation of DRX, including entering DRX active timer.

In one or more cases, a condition or trigger may include the current time during the day or night. For example, the WTRU may transmit wake-up assistance information in a subset of hours that can be configured by the network.

In one or more cases, a condition or trigger may include triggering a tracking area update or a RAN paging area update. For example, a condition or trigger is met when the WTRU determines that mobility to cell does not have the WTRU context out of a serving RAN paging area. The WTRU may include the tracking area in the WTRU assistance information. In another example, a condition or trigger is met when the WTRU determines an expiration of a “keep-alive” timer. For instance, the WTRU may start a keep-alive timer upon transmission of a first switch-on request or wake-up WTRU assistance information. The WTRU may transmit a second switch-on request or wake-up WTRU assistance information upon the expiration of that timer. In some cases, upon the expiration of the timer for the second switch-on request or wake-up WTRU assistance information, the WTRU restarts the timer. In one or more cases, the duration of the keep-alive timer and/or whether the WTRU retransmits the switch-on request or wake-up WTRU assistance information may be pre-defined or explicitly signaled by system information or in another RRC message, such as RRC connection release. In one or more cases, the duration of the timer may be function of the periodicity of a signal broadcast by the cell, such as, but not limited to a SSB. For example, the duration may be a pre-defined or configured multiple of the SSB periodicity of the cell.

In one or more cases, the WTRU may be configured to transmit wake-up WTRU assistance information or a switch-on request. For example, the WTRU transmits wake-up WTRU assistance information or a switch-on request in a subset of RRC states (e.g., RRC inactive or RRC Idle). In another example, the WTRU may transmit wake-up WTRU assistance information or a switch-on request in a subset of availability states associated with the requested cell. For instance, the WTRU may transmit wake-up WTRU assistance information or a switch-on request in a subset of availability states associated with the requested cell, such as whether the requested cell is configured in a low availability state, such as an “Off”, “deep sleep”, or “micro sleep” availability state. In another example, the WTRU transmits wake-up WTRU assistance information or a switch-on request in a subset of availability states associated with the cell on which the uplink resource is used. In another example, the WTRU transmits wake-up WTRU assistance information or a switch-on request in a subset of availability states associated with the cell, in which the WTRU receives the presence indication.

In one or more cases, the WTRU may perform measurements on capacity boosting cell(s). In one or more cases, the WTRU may provide feedback and/or measurement results to already ON macro cells/current serving cell. The WTRU may acquire SI, perform initial access, or cell search (e.g., on the requested cells). The WTRU may acquire SI, perform initial access, or cell search (e.g., on the requested cells) after transmitting a turn on request or upon receiving the response from the gNB. In some cases, a requested cell includes cell indices that are indicated as part of WTRU assistance information or switch-on requests. If the WTRU is in an RRC Idle or Inactive state, the WTRU may monitor paging following the transmission of wake-up WTRU assistance information or a switch-on request to receive the gNB response. In some cases, the WTRU may monitor paging following the transmission of wake-up WTRU assistance information or a switch-on request to receive the gNB response on a subset of paging occasions, P-RNTIs, or PDCCH resources.

In one or more cases, the WTRU may be configured to transmit wake-up WTRU assistance information. For example, the WTRU transmits wake-up WTRU assistance information as part of one or more of the following: an RRC message, an UL MAC CE report indicating the cell/carrier/BWP information, a measurement report, BSR MAC CE, an SR, or a positioning report.

In one or more cases, the WTRU may include at least one of the following as part of the wake-up WTRU assistance information. For example, as part of the wake-up WTRU assistance information, the WTRU may include cell(s) indices for which one or a combination of: the wake up is requested, a change of availability state is requested or desired, or the presence indication is detected. In some cases, the wake-up WTRU assistance information may include one or more of a gNB ID, PCI, SN id, or carrier ID. In another example, as part of the wake-up WTRU assistance information, the WTRU may include TRP(s) indices for which one or a combination of: the wake up is requested, a change of availability state is requested or desired, or the presence indication is detected. In another example, as part of the wake-up WTRU assistance information, the WTRU may include associated carriers(s) or frequency bands, for which one or a combination of: the wake up is requested, a change of availability state is requested or desired, or the presence indication is applicable. In another example, as part of the wake-up WTRU assistance information, the WTRU may include a desired availability state associated with one or more of the indicated cell(s), carrier(s), TRP(s), or frequency band(s). In another example, as part of the wake-up WTRU assistance information, the WTRU may include an RRC message (e.g. DCCH or CCCH message), which may contain a WTRU identity. The RRC message may be, for example, a DCCH message, CCCH message, or the like. In another example, as part of the wake-up WTRU assistance information, the WTRU may include a MAC CE sub-header or identifier. In another example, as part of the wake-up WTRU assistance information, the WTRU may include a request to activate/deactivate antenna chain(s) or increase the number of antenna chains. In another example, as part of the wake-up WTRU assistance information, the WTRU may include a request to activate/deactivate SSB(s) or increase the number of SSBs in the monitored set. For instance, the request may be a request to receive on-demand SSB(s). In another example, as part of the wake-up WTRU assistance information, the WTRU may include a request to activate/deactivate CSI-RS, PRS, or related resources. For instance, the request may be a request to receive on-demand CSI-RS. In another example, as part of the wake-up WTRU assistance information, the WTRU may include request or activate/de-activate transmission or reception points in a coordinated multi-point system. The coordinated multi-point system may include, for example, but not limited to, one or a combination of a cell, group of cells, or group of TRPs. In another example, as part of the wake-up WTRU assistance information, the WTRU may include a request to activate/de-activate one or more of antenna panels, chains, spatial multiplexing streams, and/or related measurement resources. In another example, as part of the wake-up WTRU assistance information, the WTRU may include the WTRU's position, a positioning report, or positioning related measurements. In another example, as part of the wake-up WTRU assistance information, the WTRU may include a radio link failure report or related measurements. In another example, as part of the wake-up WTRU assistance information, the WTRU may include a beam failure report or related measurements, for example, a beam failure MAC CE. In another example, as part of the wake-up WTRU assistance information, the WTRU may include WTRU power consumption profile, metrics, or statistics, including one or more of the active DRX mode, power headroom, and MPE-related measurements. In another example, as part of the wake-up WTRU assistance information, the WTRU may include a request for one or more of a wider BWP, a BWP change, SUL activation, a BWP index to activate, a carrier index to activate, and related measurement resources. In another example, as part of the wake-up WTRU assistance information, the WTRU may include a request to receive on-demand SSB(s) and/or CSI-RS(s) associated with one or more cells, TRP, or spatial elements. In another example, as part of the wake-up WTRU assistance information, the WTRU may include an indication of the WTRU newly arrived data type (e.g., RB type or index) and related latency metrics.

In one or more cases, the WTRU may monitor a cell specific DL resource upon transmitting wake-up WTRU assistance information or a switch on request—for measuring channel conditions, performing initial access, synchronization, and/or reception of control and/or data. Such resources may be provided on a different carrier or a different BWP. In such cases, the WTRU may activate such carrier or BWP. For example, the WTRU may monitor for a certain PSS/SSS or a CSI-RS upon transmitting a request for on-demand SSB or on-demand RS.

In one or more cases, the WTRU may transmit wake-up assistance information. For example, the WTRU transmits wake-up WTRU assistance information on an available grant. In some cases, the WTRU transmits wake-up WTRU assistance information on an available grant limited to transmission on a different serving cell. The different serving cell may be, for example, but not limited to, a cell or carrier different than the one requested or indicated in the WTRU assistance information or switch-on request. In some cases, the WTRU initiates a RACH/SR procedure based on the WTRU not having a resource(s) to transmit the assistance information. In some cases, the WTRU may trigger a new SR or BSR based on the WTRU not having a grant and/or at least one condition to transmit WTRU assistance information is met.

In one or more cases, the WTRU may perform mobility, cell search, or synchronization procedure(s) following the transmission of wake-up WTRU assistance information. For example, the WTRU may perform mobility, cell search, or synchronization procedure(s) following the transmission of wake-up WTRU assistance information on the requested cell(s). In another example, the WTRU may perform mobility, cell search, or synchronization procedure(s) following the transmission of wake-up WTRU assistance information on the requested cells after receiving a response from the network in response to the transmission of the WTRU assistance information. The response may be a HARQ ACK to the PUSCH transmission that contains the WTRU assistance information.

In one or more cases, the WTRU may perform positioning procedures, PRS measurements, or may transmit pSRS, upon triggering of wake-up WTRU assistance information.

In one or more cases, the WTRU may transmit another WTRU assistance information after the previous wake up WTRU assistance information was acknowledged. In one or more cases, the WTRU may transmit another WTRU assistance information after a timer has elapsed before receiving a response from the gNB to the WTRU assistance information.

In one or more cases, the WTRU may start a prohibit timer upon the transmission of wake-up WTRU assistance information. The WTRU may rely on HARQ retransmission mechanisms in place for the retransmission based on the WTRU assistance information being transmitted as part of an Uplink transport block. In one or more cases, the WTRU may retransmit WTRU assistance information after the expiration of the prohibit timer.

In one or more cases, the WTRU may retransmit the WTRU assistance information on one or more of a different serving cell, different carrier, different uplink (e.g., SUL), or different TRP. For example, the WTRU may retransmit the WTRU assistance information on one or more of a different serving cell, different carrier, different uplink (e.g., SUL), or different TRP after one or a combination of: the WTRU performs a configured number of retransmission attempts, the WTRU does not receive a response from the network to the wake-up WTRU assistance information, and the expiration of the prohibit timer.

In one or more cases, the WTRU may be configured with a maximum number of allowed wake-up WTRU assistance information transmissions. In some cases, the WTRU maintains a counter, which the WTRU increments by, for example, but not limited to, 1, after the transmission of a wake-up WTRU assistance information. In some cases, the WTRU may transmit multiple wake-up request signals. For instance, the WTRU may transmit multiple wake-up request signals up to the value configured for the maximum number of allowed wake-up request transmissions. In some cases, the WTRU resets the counter upon receiving a response from the gNB to the wake-up assistance information. In some cases, the WTRU moves to RRC IDLE or Inactive state after the expiration of the prohibit timer. In some cases, the WTRU moves to RRC IDLE or Inactive state or after reaching the maximum number of retransmission attempts.

In one or more cases, the wake-up indication includes two components transmitted by the WTRU consecutively. In some instances, the WTRU may transmit the two components consecutively with a timing gap in between. In some cases, the first component may be a signal, and the second component may be a channel. In one or more cases, the signal may be a sequence, such as, but not limited to, a random-access preamble. In other cases, the signal may be received using relatively low power, such as, but not limited to, a signal using ON-OFF keying. In other cases, the signal may constitute a specific signature that may trigger a change of activity level (e.g., the availability state) at the receiving node. For example, in some cases, the receiving node activates certain RF/baseband components. Following the signal, the WTRU monitors a specific set of monitoring occasions to receive a signaling for resource allocation. The WTRU transmits PUCCH and/or PUSCH in the allocated resources that may contain further wake-up assistance information.

In one or more cases, the WTRU may be configured to determine a cell's network energy saving state. In one or more cases, the WTRU considers the active availability state associated with a cell, carrier, TRP, BWP, or frequency band to be in an “Off”, “Deep sleep”, or “Micro sleep” state after reception of a DL signaling that changes the cell's or TRP's availability state. For example, the WTRU may receive a turn off command on broadcast signaling, RRC signaling, DCI (e.g., group common DCI), or a DL MAC CE. The WTRU may determine an availability state from a reception of an availability state indication from L1/L2 signalling (e.g., a group common DCI or indication).

In one or more cases, the WTRU implicitly assumes a certain availability state associated with a cell, carrier, TRP, BWP, or frequency band (e.g., “Off, “deep sleep”, “micro sleep” or dormant”) from at least one of the following. For example, the WTRU implicitly assumes a certain availability state associated with a cell, carrier, TRP, or frequency band based on a reception of a command or signal indicating a change in an availability state. The command or signal may be provided in, for example, a group common DCI in connected mode or RRC signaling. The WTRU may determine an availability state implicitly from the reception of periodic DL signaling. The WTRU may be configured or specified to associate an availability state with one or more DL signal types. For example, the DL signal types may include SSB, partial SSB, and/or one or more periodicities. In another example, the WTRU implicitly assumes a certain availability state associated with a cell, carrier, TRP, or frequency band based on the gNB DTX status. That is, the WTRU implicitly assumes a certain availability state associated with a cell, carrier, TRP, or frequency band based on whether the gNB is in active time or an associated activity timer is running. In another example, the WTRU implicitly assumes a certain availability state associated with a cell, carrier, TRP, or frequency band based on the reception of a paging message, paging DCI, paging PDSCH, or a paging related signal. The paging related signal may be, for example, a paging early indication (PEI). The paging related signal may be provided on a subset of POs. The subset of Pos may be, for example, those aligned with NES DRX cycle or a configured subset of PDCCH resources. The WTRU may assume a certain availability state after the reception of a paging message with a certain P-RNTI, a separately configured NES P-RNTI, or the NES group RNTI. The WTRU may assume a certain availability state after the reception of a paging message with a certain P-RNTI. The WTRU may be configured with one or more PEI subgroups for NES. In one or more cases, a PEI subgroup may be associated with one or more availability states. The WTRU may assume a certain availability state after reception of a PEI with an NES subgroup. For example, the WTRU assumes a certain availability state after reception of a PEI with an NES subgroup based on that subgroup being configured and/or associated with the availability state. The indication of the availability state or the availability state switch may be indicated in the paging payload. For example, the indication of the availability state or the availability state switch may be indicated in the paging payload as a flag part of the paging message or the short message. Such paging indication may further indicate an alternate cell to monitor paging while the cell from which the signaling was received is in an Off, sleep, or NES state. Such paging indication may further indicate or signal applicable reconfiguration parameters. The reconfiguration parameters may correspond to, for example, but not limited to, one or more of an initial access, applicable PRACH resources, applicable SSB/RS occasions, an applicable SI cycle, and the applicable cell(s) and associated availability states.

The WTRU implicitly assumes a certain availability state associated with a cell, carrier, TRP, or frequency band based on a lack of detection of a presence indication. For example, the WTRU may determine an availability state associated with the cell (e.g. an “Off” or “deep sleep” state) if presence indication was not detected on one or more presence indication occasions. In another instance, the WTRU may assume or change the cell's availability state after a number of consecutive misdetections or after a timer expires following no detection of a presence signal. The WTRU may determine an availability state is active or de-active after expiration of a timer associated with the availability state. In another instance, the WTRU may determine an availability state implicitly from the lack of reception of periodic DL signaling. For example, the WTRU may be configured with a signal quality threshold (e.g., an RSRP threshold). For the cases in which the WTRU does not detect a signal associated with an availability state (e.g., a presence signal or an SSB) with a signal strength above the threshold, the WTRU may assume that this availability state is not active and may assume a different availability state. This criterion may be also coupled with a lack of detection of an identifying sequence of the presence signal (e.g., detection of the PSS sequence).

The WTRU implicitly assumes a certain availability state associated with a cell, carrier, TRP, or frequency band based on a time in the day. For example, the WTRU may be configured to automatically assume a certain availability state (e.g., Off, sleep, or dormant state) for a configured subset of cells (e.g., capacity boosting cells) depending the time in the day. For instance, the WTRU may determine that a capacity boosting cell has an availability state indicated as “On” during certain hours of the day, an availability state indicated as “Deep sleep” in other configured hours, and an availability state indicated as “Off” in a third set of configured hours of the day or night. For example, the WTRU implicitly assumes a certain availability state associated with a cell, carrier, TRP, or frequency band based on an availability state of an associated cell. The associated cell may be, for example, another carrier of the same MAC entity, another carrier in the same cell group, another carrier in the same gNB, another sector in the same gNB, or a configured associated cell or capacity boosting cell. In another example, the WTRU implicitly assumes a certain availability state associated with a cell, carrier, TRP, or frequency band based on a detection of a PSS signal or a simplified/stripped down SSB signal. In another example, the WTRU implicitly assumes a certain availability state associated with a cell, carrier, TRP, or frequency band based on a detection of a PSS only signal. In another example, the WTRU implicitly assumes a certain availability state associated with a cell, carrier, TRP, or frequency band based on a detection of an RS signal (e.g., CSI-RS, PRS, TRS) or the lack thereof. In another example, the WTRU implicitly assumes a certain availability state associated with a cell, carrier, TRP, or frequency band based on the WTRU's RRC state. The RRC state of the WTRU may be, for example, an idle state, an inactive state, or in a connected mode. In another example, the WTRU implicitly assumes a certain availability state associated with a cell, carrier, TRP, or frequency band based on whether paging has been received, for example, but not limited to, within a configured time window. In another example, the WTRU implicitly assumes a certain availability state associated with a cell, carrier, TRP, or frequency band based on whether system information (e.g., periodic SI or a subset of SIBs) has been received, for example, but not limited to, within a configured time window.

In one or more cases, the WTRU may stop measurements (e.g., SSB and/or CSI-RS) upon determining that the cell is configured in an “Off” or “deep sleep” state. In other cases, the WTRU may stop measurements when the WTRU determines that there are clear configured measurement gaps. The WTRU may assume that some configured UL and DL resources are cleared or not usable in certain availability states (e.g., “Off”, “dormant” or “deep sleep” states), including configured downlink assignments, configured uplink grants, PUSCH resource for semi-persistent CSI reporting, and/or measurement gaps. In some cases, the WTRU may autonomously disable CSI-reporting in certain availability states (e.g., “Off”, “dormant” or “deep sleep” states). For example, the WTRU may autonomously disable CSI-reporting in the non-availability periods of some availability states. In one or more cases, the WTRU determines to use coverage extension methods and/or resources (e.g., default initiation of RA with msg3 repetition, PUSCH repetition, selection enhanced PUCCH coverage resources) as a function of the cell's availability state and/or channel measurements (e.g., RSRP being less than a threshold).

In one or more cases, the WTRU may be configured to determine applicable transmission, reception, and/or measurement resources per availability state. The WTRU may determine that an uplink or downlink resource or signal is available for transmission/reception and/or measurements for the determined network availability state based on the uplink or downlink resource or signal being applicable in the active availability state. The WTRU may determine that a subset of measurement resources and/or signal (e.g., SSBs, CSI-RS, TRS, PRS) occasions are not applicable in certain availability states. The WTRU may thus not measure reference signals on such measurement occasions during non-availability periods. For example, the WTRU may be configured such that a first set of RS or RS configurations (e.g., CSI-RS) is monitored during the non-availability period of an availability state. Additionally or alternatively, the WTRU may be configured such that a second set of RS or RS configurations (e.g., CSI-RS) is not monitored during the non-availability period of an availability state. The WTRU may determine that a subset of uplink or downlink resources (e.g. PRACH, PUSCH, PUCCH) are not applicable in certain availability states. The WTRU may transmit some uplink signals (e.g., SRS, pSRS, PRACH, UCI) in a subset of NW availability states.

In one or more cases, for the cases in which the WTRU determines that the network did not transmit the applicable signals on one or more measurement occasions for RLM measurements for a given RLM process, for example due to NES (e.g., during non-availability periods of an availability state), the WTRU may determine to refrain from using measurements corresponding to those skipped reference signal occasions for purposes of determining Qin/Qout and determining In-synch/out-of-synch. The WTRU may not measure measurement resources and/or occasions for RLM during non-availability periods of some availability states. In some cases, the WTRU may not alter or increment relevant RLM counters and timers based on, for example, but not limited to, skipped measurements. In some cases, the WTRU may not alter or increment measurement values/quantities during skipped measurement occasions (e.g., during non-availability periods of an availability state), including RLM, BFD and CSI measurements. The WTRU may be configured with an alternate set of values for an RLM timer and/or counters (e.g., RLM-Periodic-Timer, RLM-Occurrence-Counter, RLM-Trigger-Quantity-Counter, RLM-Trigger-Time-Counter). In some cases, the WTRU may apply the alternate set of values for the RLM timer and/or counters if a certain availability state is active.

In one or more cases, if the WTRU determines that the network did not transmit the applicable reference signals on some occasions for a BFD process, for example due to NES (e.g., during non-availability periods of an availability state), the WTRU may determine to refrain from measuring measurement resources and/or occasions for determination of BFI when the applicable CSI-RS signals are not transmitted. The WTRU may not alter or increment relevant BFD counters and timers, based on, for example, skipped measurement occasions. For the cases in which the BFI counter is above the configured threshold for triggering a beam failure, the WTRU may wait or delay the triggering of the BFR until a CSI-RS occasion associated with the NW activity state (i.e., an availability state) associated with NES (e.g., sleep, or dormant) occurs. In one or more cases, the WTRU may cancel a triggered BFR upon reception of a CSI-RS with quality metric above the configured threshold. For example, the WTRU cancels a triggered BFR upon reception of a CSI-RS with quality metric above the configured threshold, such as Qin/RSRP>threshold. In one or more other cases, the WTRU may cancel a triggered BFR upon reception of a CSI-RS with quality metric above the configured threshold (e.g., Qin/RSRP>threshold) if the CSI-RS occasion is associated with a certain availability state (e.g., NES mode or On). The WTRU may be configured with an alternate set of values for a BFD timer and/or counters (e.g., BFD counter, BFD timer, and the like). In some cases, the WTRU may apply the alternate set of values for the BFD timer and/or counters if a certain availability state is active.

In one or more cases, the NW may indicate that a subset of past measurements or measurement occasions are not valid once the WTRU wakes up. The WTRU may in turn retroactively correct RLM or BFD accumulated metrics. RLM or BFD accumulated metrics may be, for example, a number of BFIs, a number of out of synchs, and the like. In one or more cases, the WTRU may determine to remove one or more past measurement(s) based on the WTRU receiving the NW signal that is being measured (e.g., the SSB, RS, or CSI-RS) with a considerable signal strength difference. The WTRU may consider a measurement if the WTRU recognizes the sequence embedded within the SSB or CSI-RS, and otherwise may skip the measurement occasion and consider as not transmitted due to NES. For example, the WTRU may skip the measurement occasion by not performing channel measurements on the SSB or CSI-RS occasion.

In one or more cases, the WTRU may mute (e.g., not use, de-activate, or the like) some uplink and/or downlink resources for data and/or control information exchange that does not overlap with—or within a configured time period of—SSB or RS occasions of the active SSB/RS pattern or the availability periods of an availability state. The WTRU may assume multiple muting patterns/resource periodicities based on the active SSB periodicity from the patterns/periodicities configured and the active availability state.

In one or more cases, the WTRU may be configured or predefined to determine such that in some cell availability states (e.g. “Off”, “dormant” or “deep sleep” states), at least one of the following is applicable. For example, the WTRU determines that configured SSBs and/or CSI-RS are not transmitted by the gNB for this serving cell. In another example, the WTRU determines that the presence indication is transmitted by the cell in such availability state. In another example, the WTRU determines that SI and PBCH signaling may not be transmitted by the cell in such availability state. For instance, the WTRU may transmit a subset of SI or SIBs.

In one or more cases, the WTRU is configured to determine that in a subset of availability states (e.g., a micro-sleep state), reference symbols, synchronization signals, and/or system information is transmitted from the cell. In one or more other cases, the WTRU is configured to determine that in another availability state (e.g., deep sleep, dormant, or Off states), reference signals, synchronization signals, and/or system information is not transmitted from the cell.

In one or more cases, the WTRU may avoid performing procedures related SI acquisition, reacquisition, PBCH reception, cell search, mobility and/or SSBs reception from a cell in availability states that include “Off”, “dormant” or “deep sleep”. WTRUs in RRC_IDLE or in RRC_INACTIVE may stop monitoring for an SI change indication in the paging occasion of the WTRU in DRX cycles that coincide with a cell's availability state being in an “Off”, “dormant”, or “deep sleep” state. The WTRU may extend the modification period associated with an SI change indication while the cell is in certain availability states (e.g., Off, dormant, or deep sleep states). In some cases, the WTRU may not perform RLM or RLF procedures on such cell in such availability states (e.g., “Off”, “dormant” or “deep sleep). In some cases, the WTRU may suspend beam failure detection on some cells in some availability states (e.g., “Off”, “dormant” or “deep sleep” states).

In one or more cases, the WTRU may be configured for SSB/RS adaptation. In one or more cases, for the cases in which a WTRU is configured in Idle or Inactive mode, the WTRU may attempt to decode a simplified SSB (e.g., only PSS) when the network is configured in an NES state or a given availability state. The WTRU may determine a modified timing of remaining synchronization signals or SSB occasions. The WTRU may detect the remaining synchronization signals or SSB occasions based on a property of the PSS. A property of the PSS may be, for example, but not limited to, the PSS sequence or the timing of the PSS. In one or more cases, the PSS may have the same periodicity as legacy (i.e., the periodicity broadcast in system information block (SIB) signaling), but may vary periodicity of SSS and PBCH. In one or more cases, PSS may point to an alternative SSB periodicity.

The WTRU may be configured with multiple values of the field ssb-periodicityServingCell. The values may be configured, for example, using RMSI, secondary SIBs, in broadcast signaling, and the like. For a WTRU in connected mode, L1 signaling (e.g., a group common DCI) or L2 signaling (e.g., a MAC CE) may indicate one or more of switching between configured SSB periodicities, switching to a different availability state, and/or activating or deactivating certain availability states. Upon reception of such command, the WTRU may assume a different periodicity of SSBs and associated RACH resources. For example, the WTRU may assume a different periodicity of SSBs and associated RACH resources based on receiving a command, such as, but not limited to, an SSB periodicity change command or a command associated with changing an availability state.

In one or more cases, for the cases in which a WTRU is configured in Idle mode, the WTRU may determine the SSB or RS periodicity and/or whether an SSB or RS occasion is missing (i.e., whether an SSB or RS occasion is transmitted from the gNB or not) based on past measurements. For example, the WTRU may determine that an SSB or RS is not transmitted based on the current measurement in the measure net occasion differing from the X past measurement (or the moving average of past measurements) with a difference larger than a predetermined or configured value. X may be predetermined or configured. The WTRU may read, acquire, or reacquire system information based on the change between the current measurement and past measurements being larger than the threshold.

In one or more cases, for the cases in which a WTRU is configured in connected mode, the WTRU may be configured with a one or more RS periodicities/patterns (e.g., for CSI-RS, PRS, TRS, and the like). In one or more cases, the WTRU may determine the periodicity of the active RS pattern from one or more of the following: a) the difference between or a comparison of the current RS measurement occasion to a number of past measurements, b) the cell's overall signal quality (e.g., based on measurements of L3 RSRP or the presence signal), c) the active availability state, and d) the mobility status of the WTRU. The WTRU may ignore measurements of RS occasions that are not transmitted in the active RS pattern (e.g., during the non-availability period of an availability state). The WTRU may transmit a wake-up request or assistance information to request a change of RS periodicity/pattern. The gNB may signal a change of RS or SSB patterns/periodicities in an indication (e.g., a MAC CE, a DCI, and the like).

In one or more cases, the WTRU may use RACH occasions associated with active periodicity of SSBs and/or CSI-RS pattern. For example, the WTRU may use RACH occasions associated with active periodicity of SSBs and/or CSI-RS pattern such as PRACH occasions that align with transmitted SSBs, that immediately follow transmitted SSBs, or that are transmitted within a time window from SSB reception. The WTRU may assume remaining PRACH occasions are not usable. The WTRU may be configured with a PRACH occasion mask associated with one or more SSB pattern or CSI-RS pattern. The WTRU may activate a PRACH occasion mask according to the active SSB or RS pattern. For example, the WTRU may activate a PRACH occasion mask based on receiving a switching command to use a given RS or SSB periodicity or pattern. In one or more cases, the WTRU may assume that only ROs that overlap with transmitted SSB occasions (or within a period from the last SSB transmitted) are valid. In one or more cases, the WTRU may not transmit msg1 on invalid ROs.

In one or more cases, the WTRU monitors paging from a cell. For example, the WTRU may be configured to monitor paging from a cell if the cell is in a certain availability state (e.g., an ON or sleep state). The WTRU may skip waking up on DRX cycles of that cell that coincide with occasions where the cell is in other availability states (e.g., an Off, deep sleep, or dormant state). In some cases, the WTRU may monitor for a gNB wake up signaling associated with DRX or paging (e.g., DCP) in a subset of the cell's availability states (e.g., an On or sleep state).

In one or more cases, the WTRU may be configured to transmit a tracking area update (TAU) on a subset of cells in certain availability states. For example, the WTRU transmits TAU on a subset of cells, e.g., Macro cells, depending on the availability state. In some cases, the WTRU may avoid transmitting TAUs on capacity boosting cells and/or cells with a determined availability state configured in, for example, an Off, dormant, or sleep state.

In one or more cases, the WTRU may be configured to perform a cell reselection and/or a mobility procedure. For example, the WTRU performs a cell reselection and/or a mobility procedure after receiving a turn-off indication or a go-to-sleep signal. In some cases, the WTRU may receive the turn-off indication or the go-to-sleep signal in a subset of RRC states. In one or more cases, the WTRU may perform a mobility procedure in connected mode following reception of a turn-off indication. The WTRU may perform cell reselection, initial access, and/or RRC re-establishment based on the WTRU being configured in Inactive or Idle modes. If the WTRU is configured in connected or Inactive states, the WTRU transitions to Idle mode following the reception of the turn-off indication.

The WTRU may be configured or predefined with an alternate serving cell to perform initial access, mobility, or cell reselection in the event the current serving cell or a capacity boosting cell is turned off or a certain condition is met. The WTRU may be configured per broadcast or dedicated signaling with a list of fallback or alternate serving cells. In an example, WTRU may be configured per broadcast or dedicated signaling with a list of fallback or alternate serving cells, per serving cell, or per gNB. For example, the WTRU initiates a cell reselection or mobility procedure to an alternate serving cell associated with a cell or gNB from which a turn-off indication was received. In an example, the turn-off or go-to-sleep indication may dynamically indicate to the WTRU which cell to fallback or connect to, for example, by dedicated or broadcast signaling. In another example, the fallback cell may be predefined as the master node cell based on the WTRU being configured in dual connectivity. The fallback/alternate cell may be configured or predefined to be a cell associated with a different RAT or frequency band. For example, the WTRU may fallback to an LTE or an FR1 cell associated with the cell or gNB from which the turn-off indication was received. For instance, the WTRU may fallback to an LTE or an FR1 cell associated with the cell or gNB from which the turn-off indication was received based on whether the WTRU is in CA or DC using multiple RATs or multiple frequency bands.

In one or more cases, the WTRU may perform initial access/RA, mobility, and/or start related measurements on an alternate cell or a capacity boosting cell based on one or more of the following conditions being met: (a) latency associated with new data arrival, a BSR, or buffered data is stringent (e.g., lower or higher than a threshold); (b) data associated with new data arrival, a BSR, or buffered data includes data from one or more “NES” RBs or LCHs (based on RB id), including a condition that all data is from configured NES DRBs/SRBs; (c) data volume of buffered data or buffered data from NES RBs is more than, or less than, a configured threshold; (d) one or more conditional handover conditions is satisfl; (e) the WTRU being configured in a certain RRC state (e.g., an idle state, an inactive state, or connected mode); (f) measured channel conditions associated with the alternate cell and/or the best or serving cell; and (g) an indicated or measured cell resource load (utilization) metrics being associated with the alternate cell and/or the best serving cell.

In one or more cases, the WTRU may stop using initial access, measurement procedure/resources on the previous serving cell (e.g., the indicated or measured cell resource load metrics being associated with the best serving cell) if one or more of the above triggers are met, and/or the WTRU has initiated an initial access procedure on an alternate cell. In one or more cases, the WTRU may be configured with a subset of DRBs and/or SRBs as NES RBs (or LCHs), for which the WTRU may use in an NES state. In one or more cases, the WTRU may transmit a wake up request, switch on request, or WTRU assistance information based on the WTRU having buffered data from such RBs or new data has arrived from such RBs.

In one or more cases, the WTRU may be configured to associate the availability of a certain cell from the availability state of another cell. The WTRU may be predefined or configured with an association between cells. The association between cells may be, for example, but not limited to, cells that belong to the same gNB, cells that are of the same cell group, cells in CA, cells of the same frequency band, cells of the same RAT, and the like. The WTRU may change the availability state of one cell based on the WTRU changing the state for another associated cell. For example, if the WTRU determines that one cell is turned off, dormant, or in a sleep/power saving state, the WTRU changes the availability state associated with all of the cells associated with the cell that is turned off, dormant, or in a sleep/power saving state. The WTRU may activate, deactivate, and/or change an availability state for a group of cells simultaneously if the associated gNB changes its availability state.

In one or more cases, the WTRU may be configured to determine which sectors, TRPs, and/or antennas of a gNB are available or activated as a function of the availability state associated with the gNB. For example, the WTRU may determine that the gNB operates with a single sector in a power savings availability state (e.g., a sleep, dormant, or off state). The WTRU may determine that the gNB operates with a different number of active cells/PCIs or a number of cells that are part of the same gNB if the gNB is in another availability state (e.g., an On or micro-sleep state).

In one or more cases, the WTRU may be configured to monitor an indication that may characterize a level of network activity (e.g., an availability state). In an example, the network activity may be associated with a gNB and/or a cell. The WTRU may assume the same availability state for all cells that are a part of the same gNB, for example, cells of the same MAC entity. The network activity indication (e.g., the presence indication) may include a channel (e.g., a PDCCH) and/or a signal (e.g., a sequence). The activity indication may indicate the level of activity (e.g., a reduced activity) that the WTRU may expect from the associated gNB and/or cell. In some cases, the activity indication may contain activity information of other gNBs/cells.

In one or more cases, the activity indication may be a PDCCH containing group common signaling. For example, the NW may transmit a group common DCI to a group of WTRUs (e.g., the WTRUs in the serving cell) indicating a change of an activity state or activity level in UL and/or DL. The group of WTRUs may be, for example, the WTRUs in the serving cell. The CRC of the PDCCH may be scrambled with a dedicated “activity indication RNTI.” A WTRU may be configured with at least one search space associated with the monitoring occasions of the activity indication PDCCH.

In one or more cases, the signaling within the PDCCH or the activity indication may contain one or more of the following. For example, the signaling within the PDCCH or the activity indication may contain an expected activity level of the associated gNBs/cells over a specific time interval (e.g., the time interval for an availability state). In some cases, the WTRU may configure and/or predetermine activity levels, which may, for example, include regular activity and reduced activity. In some cases, the signaling may indicate the activity level. For example, bit “1” may indicate regular activity. In another examp“e” bit “0” may indicate reduced activity.

In another example, the signaling within the PDCCH or the activity indication may contain, for each activity level (e.g., availability state), defined transmission and reception attributes. For example, during reduced activity, the WTRU may not be expected to monitor certain PDCCH search spaces (including, for example, one, more, or all SSs), receive a certain type of PDSCH (including, for example, one, more, or all PDSCH), transmit PUCCH/PUSCH, and/or perform certain measurements. In one or more cases, the WTRU may determine the scheduling cell (e.g., for cross-carrier scheduling) as a function of the availability state associated with the activated carriers. For example, the WTRU may stop monitoring PDCCH for cross-carrier scheduling based on the availability state being changed or activated on such carrier, In another example, the WTRU may stop monitoring PDCCH for cross-carrier scheduling based on the availability state being changed or activated on such carrier, while the WTRU monitors PDCCH from another carrier (e.g., that is on or is not in NES state).

In another example, the signaling within the PDCCH or the activity indication may contain a set of configurations that may be associated with an activity level and used/applied when that activity level is indicated. For example, the set of configurations may include SS configurations, CSI reporting configurations, indices of transmitted SSBs, and the like. In one or more cases, each set of configurations may have an attribute associated with an activity level. For example, an attribute such as a tag may be set to “reduced activity”.

In another example, the signaling within the PDCCH or the activity indication may contain the time interval over which an activity level is assumed. In such cases, the WTRU may signal the time interval over which an activity level is assumed in the PDCCH or part of the activity indication. In some cases, the time interval may be indicated using a bitmap in which each bit in the bitmap may be associated with a specific duration, for example, a slot or a frame. For example, bit “1” may indicate regular activity. In another example, bit “0” may indicate reduced activity on an associated frame. In some other cases, the time interval may be indicated with a start time and length of interval. The start time may be defined. For example, the start time may be determined by adding a fixed offset to the time the indication is received. The length of the interval may be configured or signaled in the indication PDCCH.

In another example, the signaling within the PDCCH or the activity indication may contain a predetermined time interval over which an activity level is assumed.

In one or more cases, the indication may include a go-to-sleep signal, for example, a predefined sequence. For instance, when WTRU detects a go-to-sleep signal, WTRU may expect a reduced activity level over a specific time duration. In one or more cases, the WTRU may activate C-DRX for the indicated period of time. Alternatively, in another example, two sequences may be used to indicate regular activity and reduced activity.

In one or more cases, a WTRU may be configured to transmit a “leave indication” signal prior to or upon cell re-selection to a new cell. The “leave indication” signal may have the same structure as a “switch-on request” signal. The “switch-on request” signal and “leave indication” signal may be generated using first and second parameters respectively. The first and second parameters may be related by a pre-defined relationship or signaled higher layers. For example, a WTRU may receive RRC signaling (e.g., system information or RRC connection release) indicating whether to transmit a “leave indication” signal prior to, or upon cell reselection, and configuration of parameters for the generation of the signal. A generating parameter may include, for example, a scrambling identity or a base sequence, based on the structure of the signals.

In one or more cases, the parameter configuration for a “leave indication” signal may depend on the identity of the serving cell prior to cell reselection. In one or more other cases, the parameter configuration for a “leave indication” signal may depend on the identity of the serving cell after cell reselection. In the latter case, the “leave indication” signal may correspond to a “new cell indication” signal.

In some cases, a “switch-on request”, “leave indication,” or “new cell indication” signal may include a PRACH transmission. In such cases, the WTRU is configured to perform a RACH procedure to indicate the switch-on request (e.g., a RACH preamble may include the switch-on signal). The RACH procedure may be considered successful based on the WTRU receiving a random access response corresponding to the PRACH.

In other cases, the WTRU may be configured to initiate an RRC connection request to the new cell after reselection with possibly a new cause indication. The RRC connection request may be signaled by RRC (e.g., system information or RRC connection release). The RRC may be indicated separately for each source serving cell (e.g., before cell reselection). The RRC may be indicated separately for each target serving cell (e.g., after cell reselection). The RRC may be indicated separately for each pair of source and target serving cells (e.g., for cell reselection from a specific source cell to a specific target cell). In one or more cases, the transmission of a “leave indication” or “new cell indication” signal by a WTRU(s) in idle mode may determine when a cell could be turned off. For example, the transmission of a “leave indication” or “new cell indication” signal by a WTRU(s) in idle mode may determine that a cell could be turned off when no or few WTRU(s) are camping on a cell.

In one or more cases, the WTRU may be configured to operate in frequency and spatial domains. For example, the WTRU may turn off NUL and rely on SUL. The WTRU may turn off NUL and rely on SUL, for example, based on an associated cell being turned off or configured in a power savings state.

In one or more cases, the WTRU may be configured, predefined, or indicated to turn off a NUL uplink carrier. In one or more cases, the WTRU may be configured, predefined, or indicated to rely on SUL in one or more availability states. For example, the WTRU may deactivate the NUL carrier and/or UL carriers.

In some cases, the WTRU may be configured, predefined, or indicated to deactivate one or more uplink carriers, such as, but not limited to, secondary SCells. In some cases, the WTRU may be configured, predefined, or indicated to rely on the PCell based on the associated serving gNB being configured in one or more availability states. For example, the WTRU deactivates SCells if the gNB is in a certain availability state. For instance, the WTRU deactivates SCells if the gNB is in a certain availability state if the associated cell is turned off or configured in a power savings state.

In some cases, the WTRU may be configured, predefined, or indicated to switch the WTRU's active UL and/or DL bandwidth part to the initial BWP or the default BWP. For example, the WTRU switches the WTRU's active UL and/or DL bandwidth part to the initial BWP or the default BWP if the associated serving cell is configured in one or more availability states. For example, the WTRU deactivate SCells if the gNB is in a certain availability state. For instance, the WTRU deactivate SCells if the associated cell is turned off or configured in a power savings state. In one or more cases, the WTRU may be configured with a specific NW power savings BWP. In some cases, the WTRU may be configured with a specific NW power savings BWP (e.g., NES BWP). In some cases, the WTRU may be configured with a specific NW power savings BWP (e.g., NES BWP), per availability state. In some cases, the WTRU may switch to the NW power savings BWP based on an associated cell being (or determined to be) in a certain availability state (e.g., “Off”, “Sleep”, and other like states). In some cases, the WTRU may be configured to switch the WTRU's active UL and/or DL active BWP to the NW power savings BWP. For example, the WTRU switches the WTRU's active UL and/or DL active BWP to the NW power savings BWP if the WTRU does not receive availability signals in the current BWP. In some cases, the WTRU switches the WTRU's active UL and/or DL active BWP to the NW power savings BWP if the WTRU does not receive availability signals in the current BWP after a number of misdetections. In some cases, the WTRU switches the WTRU's active UL and/or DL active BWP to the NW power savings BWP if the WTRU does not receive availability signals in the current BWP after an expiration of a timer. For example, the WTRU may receive an indication (e.g., common L1 signaling or DCI or L2 signaling, such as MAC CE) indicating a switch to the NES BWP based on reception of a common cell signal, or lack thereof. The WTRU may transmit HARQ feedback or an acknowledgment to the reception of the NES BWP switching command/indication. The WTRU may switch to the NES BWP after transmitting such feedback and/or upon reception of a second confirmation DL signal on the existing active BWP. In another example, the WTRU may implicitly switch to another BWP (e.g., the NES BWP) if a DL signal is not detected. In another example, the WTRU may implicitly switch to another BWP (e.g., the NES BWP) if a DL signal is not detected within a period of time and/or based on measured channel conditions. In another example, the WTRU may implicitly switch to another BWP (e.g., the NES BWP) if the DL signal does not include measured channel conditions above a threshold. In another example, the WTRU may implicitly switch to another BWP (e.g., the NES BWP) if a DL signal is not detected (e.g., the DL signal does not include measured channel conditions above a threshold) within a period of time and/or based on measured channel conditions. The WTRU may switch to the NES BWP upon expiration of the BWP-inactivity-timer or another NES BWP-inactivity-timer. The BWP-inactivity-timer or another NES BWP-inactivity-timer may reset upon reception of a DL signal associated with the availability state/NES state of the gNB.

In one or more cases, the presence indication associated with a cell may indicate which carriers to activate. In some cases, the WTRU may start measuring resources (e.g., CSI resources or channel quality) upon receiving a presence indication associated with a certain carrier. The WTRU may activate a certain SCell upon reception of a presence indication associated with the Scell or the associated gNB. The WTRU may deactivate a carrier or an SCell if the WTRU does not receive the presence indication associated with the SCell or the associated gNB. In some cases, the WTRU may deactivate a carrier or an SCell if presence indication associated with the SCell or the associated gNB is not received following a number of failures to receive the detected presence indications or after the expiration of a timer (e.g., the Scell deactivation timer).

In one or more cases, the WTRU may be configured to receive signaling from the network to deactivate cells, carriers, and/or BWPs on a certain frequency band or carrier. For example, the WTRU may turn off or deactivate cells on FR2 frequency bands. In some examples, the WTRU may turn off or deactivate cells on FR2 frequency bands if the WTRU receives a turn-off indication to turn off or deactivate the cells on FR2 frequency bands. In some examples, the WTRU may turn off or deactivate cells on FR2 frequency bands if the WTRU does not detect a presence indication associated with such frequency band. In other examples, the WTRU may turn off or deactivate cells on a certain carrier or frequency band if the WTRU determines that the cell is in a certain availability state (e.g., an Off or dormant state).

In one or more cases, the WTRU may be configured to provide assistance information requesting a change/modification in gNBs availability state and/or spatial resources assignment. Spatial resources may include, for example, but not limited to, TRPs, antennas, ports, sectors, and the like. In one or more cases, a WTRU may request additional and/or different sets of antennas, ports, beams, and the like based on certain measurements (e.g., SSB, PRS, CSI-RS). For example, if SSB measurements (e.g., SS-RSRP, SS-RSRPB, SS-RSRQ, SS-SINR, and the like) fall below a certain threshold, the WTRU indicates the need for additional SSB beams from gNB. SSB measurements falling below a certain threshold may indicate low pathloss/channel quality. In some cases, the additional SSB beams may be narrower beams within the same wide SSB beam. In other cases, the additional beams may be narrower beams within a new SSB beam. The new SSB beam may be, for example, a wide beam and/or a narrow beam.

In some cases, the gNB may utilize periodic or aperiodic CSI reports from the WTRU to assist in selecting the set of beams to activate. In some cases, the gNB may utilize periodic or aperiodic CSI reports from the WTRU to assist in selecting which beams the gNB may turn off. In some cases, the gNB may turn off beams that are not useful from a WTRU coverage perspective.

In one or more cases, the gNB may utilize WTRU specific SRS transmissions to estimate UL channel quality. The gNB may use the WTRU specific SRS transmissions when determining whether the gNB may need to change the gNB's availability state and/or spatial domain resource allocation. For example, if a WTRU or set of WTRU SRS transmissions are indicative of poor channel quality over a portion of the frequency, the entire frequency, and/or an antenna port/beam assignment, the gNB may utilize WTRU-specific SRS transmissions to switch/modify the gNBs current TRP antenna/beam/port configuration. In one or more cases, the WTRU may transmit SRS transmissions in a subset of availability states. In one or more other cases, the WTRU may transmit SRS transmissions using a different periodicity or configuration depending on the serving cell's availability state.

In one or more cases, the WTRU may indicate a need for an additional number of antennas, ports, beams, and the like, if CSI-RS related measurements (e.g., RSRP, RSRQ, SINR, and the like) are below a certain threshold. For the cases in which the CSI-RS related measurements are below a certain threshold, the TRP configuration at the gNB may be sub-optimal. In another example, the WTRU may indicate a preference of a certain set of spatial resources, for example, but not limited to, ports, beams, and TRPs (i.e., in case multiple TRPs are associated with this WTRU) based on measurements associated with these resources. Each set of spatial resources may be abstracted by an index configured by RRC signalling. The WTRU may report such preferred index as part of UCI or a MAC CE. In an example, if measurements on a certain's′bset ‘k’ of resources are above a threshold value ‘(’.e., ‘k’ being the strongest resources ‘o’t of ‘n’ resources), the WTRU may indicate a preference for this subset of resources. In one or more cases, the gNB may utilize the indicated preference to modify the gNB availability state. For example, the gNB may utilize the indicated preference to modify the gNB availability state by turning off the spatial resources that are below the threshold.

In one or more cases, the WTRU may indicate the need for a change in the gNBs availability state and/or a change of spatial resources assignment if reference signal measurements (e.g., RSRP, RSRQ, and the like) are above a certain threshold, but below another threshold. For example, if the serving cell is above a threshold (e.g., an Event A1 threshold, which does not trigger a mobility procedure), but below another threshold that is greater than the Event A1 threshold, the WTRU may determine cells availability states (e.g., beam, antennas/ports, and the like) based on serving cell being above the Event A1 threshold but below another threshold in conjunction with information regarding the network availability state and/or cell/TRP presence indication information by WTRU. In one or more cases, the WTRU may signal an indication to the gNB to request a change in/or additional spatial resources.

In one or more cases, the WTRU may request an additional spatial resource allocation or a change of spatial resource allocation based on the quality of the WTRU's CSI report. In some cases, this indication may be triggered based on a poor CQI and/or rank measurement.

In one or more cases, the WTRU may utilize a positioning-based measurement to request a change in a gNB's availability state and/or spatial resource assignment. In an example, the WTRU may request the change if the DL PRS-RSRP per beam or TRP falls below a certain threshold. In another example, the WTRU may request to switch a current spatial resource assignment if the DL RSTD of PRS between other TRPs and the current serving (reference) TRP exceeds a threshold. In another example, WTRU may utilize rx-tx measurements from multiple TRPs (e.g., serving, and additional TRPs) to trigger a request for additional spatial resources. The WTRU may use the rx-tx measurements in conjunction with information regarding the network availability state and/or cell/TRP presence indication information. The WTRU may use the rx-tx measurements in conjunction with information regarding the network availability state and/or cell/TRP presence indication information when indicating a preference for a change in a cell's availability state and/or a current spatial resource allocation (e.g., beam, antennas/ports, and other like resources)

In one or more cases, WTRU may request a change in a gNB's spatial resource allocation if there is a change in the status of buffered data at the WTRU. In some cases, this change in a gNB's spatial resource allocation may be an increase of buffered data. For instance, the increase of buffered data may indicate, an insufficient rate of depletion of buffered data. In some cases, this change in a gNB's spatial resource allocation may correspond to a change in characteristics of buffered data. For example, the change in characteristics of buffered data may be a change in priority levels/QoS of traffic being served, volume of data, active number of LCGs, and the like.

In one or more cases, the gNB may utilize the indicated WTRU assistance information to optimize network side power consumption. In some cases, optimizing network side power consumption may include prioritizing macro TRP energy savings via one or more of antenna/port muting, adaptive sectorization, and selective SSB adaptation (e.g., a wider beamwidth or a reduced number of beams) when appropriate (e.g., in a low load scenario). Optimizing network side power consumption via including prioritizing macro TRP energy savings may yield the greatest network side savings (i.e., in PA and BB power consumption). In other examples, it may be beneficial to have more cells/TRPs active. For example, under a high load scenario that needs the macro TRP to be in a full availability state, it may be beneficial to have multiple small cells in a full availability state as well. In particular, it may be beneficial to have multiple small cells in a full availability state if the small cells are NR micro deployments operating in a dense Urban deployment. In such scenarios, the added capacity of multiple small cells may result in quicker transmissions, allowing for more time for sleep, and thereby reducing network side power consumption.

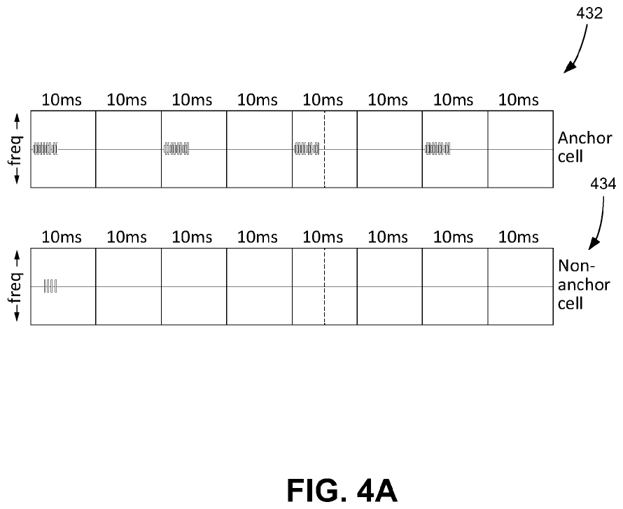

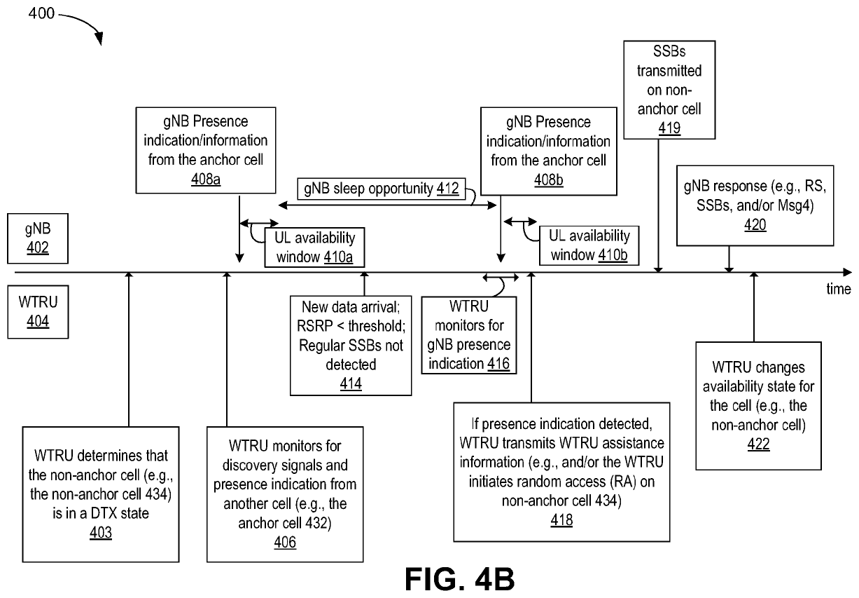

FIG. 4A is a diagram illustrating an example configuration of SSB transmission for an anchor cell and a non-anchor cell. The anchor cell 432 may be in an active state. The anchor cell 432 may be configured to transmit discovery signals (e.g., of SSB transmission, SIB transmission, RS transmissions, and the like) at a periodic interval. The non-anchor cell 434 may be in a low availability state (e.g., an “Off”, “deep sleep”, or “micro sleep” availability state). The non-anchor cell 434 may be configured to transmit discovery signals (e.g., of SSB transmission, SIB transmission, RS transmissions, and the like) at a periodic interval that is less than (e.g., slower) than the anchor cell.

FIG. 4B illustrates an example diagram illustrating WTRU assistance information transmitted based on a detection of presence indication. FIG. 4B illustrates the WTRU procedure 400 for switch-on requests for a cell configured with presence indication. Although illustrated with steps 403-422, in some examples the procedure 400 may include only a subst of the steps 430-422 (e.g., one or more of the steps 403-422 may be omitted). In an example, a WTRU 404 accesses resources in a cell, gNB, such as gNB 402, or TRP with a presence indication. For instance, the WTRU 404 determines at 403 that the non-anchor cell (e.g., non-anchor cell 434) may be configured in a DTX state. To access resources, the WTRU 404 may be configured with monitoring occasions to detect a presence indication associated with a cell, TRP, or carrier. As such, the WTRU 404 monitors at 406 for discovery signals and/or presence indication from another cell (e.g., the anchor cell 432). In some cases, the carrier may be associated with a different cell. In some cases, presence indication may be a DL signal, such as, but not limited to, a stripped-down SSB, PRS, wake-up signal, CSI-RS, DCI, and other like DL signals. In some cases, presence indication may be an L2 message, such as, but not limited to, a MAC CE or an RRC message. In some cases, the L2 message may be from a different cell or TRP. In one or more cases, the WTRU 404 may be configured to monitor for discovery signals and/or a presence indication associated with another cell at 406, such as an anchor cell, such as gNB 402. The gNB 402 may monitor for presence indication information at 408a. For example, the gNB 402 may monitor for presence signal/information transmitted from an anchor cell. Presence indication (i.e., a presence signal) may be, for example, but not limited to, an SSB, CSI-RS, and the like. Presence information may be, for example, but not limited to, system information, including resources for accessing a non-anchor cell. The anchor cell may be, for example, but not limited to, an SpCell, PCell, a primary SCell, and the like. The UL availability window 410a (as well as UL availability window 410b) may correspond to a period of time in which the presence signal or information reception is detected and/or the period of time after the WTRU transmission of the wake-up request or assistance information. During the UL availability window, the WTRU may transmit uplink signals and channels. For example, the WTRU may transmit uplink signals and channels on configured UL channel resources on the non-anchor cell at which the wake-up request was transmitted. In one or more cases, gNB sleep opportunity 412 may correspond to a Cell DTX/DRX duration during which a cell is not expected to transmit a subset of DL signals/channels and/or receive on UL channels/signals. The Cell DTX/DRX duration may be, for example, an availability state associated with gNB sleep. In one or more cases, the WTRU triggers the transmission of a wake-up request or information at 414 for the cases in which the measured channel conditions are less than a threshold (e.g., RSRP) and/or in the SSBs associated with the non-anchor cell or the anchor cell were not detected. In an example, the SSBs associated with the non-anchor cell or the anchor cell may not be detected if the WTRU measures channel conditions less than a threshold.

In one or more cases, gNB 402 may be configured in a sleeping or off state. For example, the WTRU 404 may be configured to monitor at 416 for a presence indication associated with the sleeping/off gNB 402 after satisfying conditions for transmitting a switch-on request and/or assistance information. The assistance information may correspond to, for example, data arrival, lack of grant, poor coverage, high load, and like information. In one or more cases, the WTRU 404 is configured to successfully receive the presence indication, such as gNB presence indication 408b. For example, the WTRU 404 may receive gNB presence indication and/or information from the anchor cell 432. In such cases, the WTRU may assume an availability state associated with the cell (e.g., “Off” or “Deep sleep” state). In one or more cases, the WTRU is configured to transmit at 418 one or more of a switch-on request, WTRU assistance information, or initiate a random access (RA) procedure (e.g., a RACH or PRACH procedure) after successful detection of a presence signal. The WTRU may transmit one or more of the a switch-on request, WTRU assistance information, or RA within a UL availability window 410b following the detection). The WTRU may transmit the RA to initiate RA on, for example, the non-anchor cell.

At 419, the gNB 402 may transmit SSBs on a non-anchor cell (e.g., non-anchor cell 434). The gNB 402 may transmit at 420 an additional RS, SSBs, Msg4, and/or CSI-RS resources. In one or more cases, the gNB 402 may transmit at 420 an additional RS, SSBs, Msg4, and/or CSI-RS resources in response to receiving the assistance information and/or switch-on request. In one or more cases, the WTRU is configured to monitor for an additional RS, SSBs, Msg4, and/or CSI-RS resources after the transmission switch-on request or reception of a response to the switch-on request. In one or more cases, at 422, the WTRU is configured to change the cell's availability state (e.g., to “On” or “micro sleep” state). For example, the WTRU is configured to change the availability state for the non-anchor cell. The WTRU may change the cell's availability state, for example, after successfully receiving a response from the requested cell to the transmitted switch-on request.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-16. (canceled)

17. A wireless transmit/receive unit (WTRU) comprising:
a processor configured to:
receive configuration information, wherein the configuration information indicates a first periodicity and a second periodicity, wherein the first periodicity is associated with a reduced uplink cell activity level or a reduced downlink cell activity level of a first cell and the second periodicity is associated with a reduced uplink cell activity level or a reduced downlink cell activity level of a second cell;
receive downlink control information (DCI), wherein the DCI indicates whether to activate the reduced uplink cell activity level or the reduced downlink cell activity level of the first cell and indicates whether to activate the reduced uplink cell activity level or the reduced downlink cell activity level of the second cell, and wherein a cyclic redundancy check (CRC) of the DCI is scrambled with a dedicated radio network temporary identifier (RNTI);
start a first activity timer for the first cell according to the first periodicity and based on the DCI indicating to activate the reduced uplink cell activity level or the reduced downlink cell activity level of the first cell;
start a second activity timer for the second cell according to the second periodicity and based on the DCI indicating to activate the reduced uplink cell activity level or the reduced downlink cell activity level of the second cell;
send one or more uplink signals via the first cell during a first availability period based on the DCI indicating that the reduced uplink cell activity level of the first cell is active or receive one or more downlink signals via the first cell during the first availability period based on the DCI indicating that the reduced downlink cell activity level of the first cell is active, wherein the first availability period is based on the first activity timer for the first cell; and
send one or more uplink signals via the second cell during a second availability period based on the DCI indicating that the reduced uplink cell activity level of the second cell is active or receive one or more downlink signals via the second cell during the second availability period based on the DCI indicating that the reduced downlink cell activity level of the second cell is active, wherein the second availability period is based on the second activity timer for the first cell.

18. The WTRU of claim 17, wherein the processor is configured with specific search space for monitoring the PDCCH using the dedicated RNTI.

19. The WTRU of claim 17, wherein the dedicated RNTI is associated with power savings operation.

20. The WTRU of claim 17, wherein the one or more uplink signals comprises a scheduling request.

21. The WTRU of claim 17, wherein the one or more uplink signals comprises a channel quality indicator (CQI) report.

22. The WTRU of claim 17, wherein the one or more downlink signals is a physical downlink control channel (PDCCH) transmission.

23. The WTRU of claim 17, wherein the DCI corresponds to group common signaling.

24. The WTRU of claim 17, wherein a single bit in the DCI indicates the activity level.

25. The WTRU of claim 17, wherein the processor is configured to manage the activity levels of the reduced downlink activity levels and the reduced uplink activity levels independently.

26. The WTRU of claim 17, wherein the DCI corresponds to a presence indication.

27. A method performed by a wireless transmit/receive unit (WTRU), the method comprising:
receiving configuration information, wherein the configuration information indicates a first periodicity and a second periodicity, wherein the first periodicity is associated with a reduced uplink cell activity level or a reduced downlink cell activity level of a first cell and the second periodicity is associated with a reduced uplink cell activity level or a reduced downlink cell activity level of a second cell;
receiving downlink control information (DCI), wherein the DCI indicates whether to activate the reduced uplink cell activity level or the reduced downlink cell activity level of the first cell and indicates whether to activate the reduced uplink cell activity level or the reduced downlink cell activity level of the second cell, and wherein a cyclic redundancy check (CRC) of the DCI is scrambled with a dedicated radio network temporary identifier (RNTI);
starting a first activity timer for the first cell according to the first periodicity and based on the DCI indicating to activate the reduced uplink cell activity level or the reduced downlink cell activity level of the first cell;
starting a second activity timer for the second cell according to the second periodicity and based on the DCI indicating to activate the reduced uplink cell activity level or the reduced downlink cell activity level of the second cell;
sending one or more uplink signals via the first cell during a first availability period based on the DCI indicating that the reduced uplink cell activity level of the first cell is active or receive one or more downlink signals via the first cell during the first availability period based on the DCI indicating that the reduced downlink cell activity level of the first cell is active, wherein the first availability period is based on the first activity timer for the first cell; and
sending one or more uplink signals via the second cell during a second availability period based on the DCI indicating that the reduced uplink cell activity level of the second cell is active or receive one or more downlink signals via the second cell during the second availability period based on the DCI indicating that the reduced downlink cell activity level of the second cell is active, wherein the second availability period is based on the second activity timer for the first cell.

28. The method of claim 27, wherein the WTRU is configured with specific search space for monitoring the PDCCH using the dedicated RNTI.

29. The method of claim 27, wherein the dedicated RNTI is associated with power savings operation.

30. The method of claim 27, wherein the one or more uplink signals comprises a scheduling request.

31. The method of claim 27, wherein the one or more uplink signals comprises a channel quality indicator (CQI) report.

32. The method of claim 27, wherein the one or more downlink signals is a physical downlink control channel (PDCCH) transmission.

33. The method of claim 27, wherein the DCI corresponds to group common signaling.

34. The method of claim 27, wherein a single bit in the DCI indicates the activity level.

35. The method of claim 27, wherein the activity levels of the reduced downlink activity levels and the reduced uplink activity levels are managed independently.

36. The method of claim 27, wherein the DCI corresponds to a presence indication.
